(19) United States
(12) Patent Application Publication
(10) Pub. No.: US 2024/0414190 A1
(43) Pub. Date: Dec. 12, 2024

(54) SYSTEM AND METHOD FOR UTILIZING LARGE LANGUAGE MODELS FOR MITIGATION OF CYBER THREATS AND REMEDIATION OR RESTORATION OF FUNCTIONALITY OF A CYBERSECURITY SYSTEM

(71) Applicant: Darktrace Holdings Limited, Cambridge (GB)

(72) Inventors: Jake Lal, Cambridge (GB); John Boyer, Cambridge (GB)

(21) Appl. No.: 18/737,534

(22) Filed: Jun. 7, 2024

Related U.S. Application Data
(60) Provisional application No. 63/472,227, filed on Jun. 9, 2023.

(51) Int. Cl. H04L 9/40

(52) U.S. Cl. CPC H04L 63/1441; H04L 63/1425; H04L 63/205

(57) ABSTRACT

A system operating with a cybersecurity system to enhance cyber threat detection is described. The system features a first and second orchestrator modules. The first orchestrator module includes at least a first large language model and is configured to perform artificial intelligence-based simulations of cyber-attacks to determine (i) how a simulated cyber-attack might occur in a selected computing device and (ii) how to use simulated cyber-attack information to preempt possible escalations of an ongoing actual cyber-attack. The second orchestrator module includes at least a second large language model and is configured to (i) perform a remediation task to correct one or more misconfigurations in one or more components associated with the cybersecurity system and (ii) return the one or more components back to a trusted operational state.

### CROSS-REFERENCE TO RELATED APPLICATIONS

This application claims the benefit of priority on U.S. Provisional Patent Application No. 63/472,227 filed on Jun. 9, 2023, the entire contents of which are incorporated by reference herein.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Cybersecurity and in an embodiment use of Artificial Intelligence in cybersecurity.

### BACKGROUND

Cybersecurity attacks (hereinafter, “cyber-attacks”) have become a pervasive problem for enterprises as many computing devices and other resources have been subjected to attack and compromised. A “cyber-attack” constitutes a threat to security of an enterprise, which may be broadly construed as an enterprise network, one or more computing devices connected to the enterprise network, stored or in-flight data accessible over the enterprise network, and/or other enterprise-based resources. This cybersecurity threat (hereinafter, “cyber threat”) may involve a malicious or criminal action directed to an entity (e.g., enterprise, individual, group, etc.) such as introducing malware (malicious software) into the enterprise. Originating from an external endpoint or an internal entity (e.g., a negligent or rogue authorized user), the cyber threat may range from theft of user credentials to even a nation-state attack, where the actor initiating or causing the security threat is commonly referred to as a “malicious” actor.

While cybersecurity products are used to detect and prioritize cyber threats against the enterprise, there are no conventional cybersecurity products to determine preventive and/or remedial actions for the enterprise in response to those cyber threats. In particular, there are no conventional cybersecurity products featuring one or more LLMs that are adapted to (i) influence actions performed by certain logic (engines), (ii) provide explanations in a Natural Language Processing (NLP) format directed to the influenced actions, and (iii) identify device configuration and operability where adjustments may improve security of a computing device or network protected by the AI-based cybersecurity system, and (iv) provide explanations in a NLP format the benefits and/or adjustments recommended to improve device/network security.

### SUMMARY

Methods, systems, and apparatus are disclosed for an Artificial Intelligence-based (AI-based) cybersecurity system. The AI-based cybersecurity system utilizes large language models (and the associated generative AI-creating algorithms that can generate new content based on patterns learned from existing data, sometimes compositely referred to as Large Language Models or ‘LLMs’ herein) in example aspects as follow. First, the cybersecurity system can use LLMs as an orchestrator in detection of potential cyber threats and adjust sensitivity of certain cyber threat detection based, at least in part, on data associated with current cyber threats detected externally from the AI-based cybersecurity system (hereinafter, the “threat landscape information”). Second, the cybersecurity system can use LLMs as an orchestrator in conducting and adjusting autonomous responses to potential cyber threats and provide context associated with the rationale for the autonomous responses. The adjustment of the autonomous response module may include increasing severity of response action, decreasing severity of response actions, additional response actions, and/or decreasing number of response actions. Third, the cybersecurity system can use LLMs as an orchestrator in mitigation (e.g., remediation and/or mediation) by autonomously conducting and/or generating recommendations for display directed to adjustments in certain computing devices to reduce risk of being targeted for a cyber-attack and/or restore/perform disaster recovery after detection of an on-going or successful cyber-attack. Fourth, the cybersecurity system can use LLMs as an orchestrator in misconfiguration adjustment through evaluation and heightened handling of non-compliance with best practices in response to threat landscape information identifying such misconfigurations being exploited by threat actors. Fifth, the cybersecurity system can implement an LLM in front of (or in-line with) an autonomous response engine to mitigate a potential cyber-attack in which the autonomous response engine is configured to make informed decisions as to the response(s) to be conducted (and the order of the response(s)) to defend against the potential cyber-attack. Sixth, the cybersecurity system can use of LLMs to provide explanation for adjustments to operability of the cybersecurity system and/or the particular components performing such operations. Seventh, the cybersecurity system can use different LLMs and human language identification for automatic translation of content within the user interface, enabling localization. Lastly, the cybersecurity system can have the LLM perform many additional tasks as discussed herein.

These and other features of the design provided herein can be better understood with reference to the drawings, description, and claims, all of which form the disclosure of this patent application.

### BRIEF DESCRIPTION OF THE DRAWINGS

The drawings refer to some embodiments of the design provided herein in which:

FIG. 1 is an illustrative logical representation of an orchestration component configured to (i) influence actions by logic operating within the cybersecurity appliance that autonomously detect and respond to cyber threats and (ii) provide explanations in a Natural Language Processing (NLP) format directed to the influenced actions.

FIG. 2 is an illustrative logical representation of the orchestration component configured to control operability of logic within the cybersecurity appliance based, at least in part, threat landscape information received from external sources.

FIG. 3 is a detailed block diagram of an embodiment of the orchestration component of FIG. 2 operating with a cybersecurity appliance.

FIG. 4 is an illustrative embodiment of orchestrator modules associated with the cyber-attack simulation engine and the cyber-attack restoration engine communicatively coupled to the orchestration component of FIG. 2 to generate recommendation messages based on portions of the threat landscape information.

FIG. 5 is an illustrative embodiment of the cybersecurity appliance of FIGS. 1-3.

FIG. 6 is an illustrative embodiment of an interactive display screen rendered by a computing device based on signaling from the intelligent orchestration component and/or the remediation suggestion component.

FIG. 7 illustrates an embodiment of the AI based cybersecurity appliance plugging in as an appliance platform to protect an enterprise.

FIG. 8 illustrates a diagram of an embodiment of a computing device that can be part of an AI-based cybersecurity system including the cybersecurity appliance of FIG. 3 and operating with the orchestration component of FIGS. 1-2.

FIG. 9 illustrates an embodiment of the cyber-attack simulation engine operating in concert with the AI-based cybersecurity appliance.

FIG. 10 illustrates an embodiment of a graph illustrating AI-based simulations.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, or the like, in order to provide a thorough understanding of the present design. It will be apparent, however, to one of ordinary skill in the art that the present design can be practiced without these specific details. Hence, well known components or methods have not been described in detail or displayed in a block diagram in order to avoid unnecessarily obscuring the present design. While specific numeric references, such as a first Large Language Model (LLM), have been made, these specific numeric references should not be interpreted as a literal sequential order but rather interpreted that the first LLM may be different, physically or in operation, from a second LLM. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

### 1. General AI-Based Cybersecurity System Summary

Herein, an Artificial Intelligence-based (AI-based) cybersecurity system is described. The AI-based cybersecurity system includes several AI-based engines configured to communicate and cooperate with each other, including the cybersecurity appliance with a cyber threat detection engine, a cyber threat autonomous response engine, a cyber-attack simulation engine, and a cyber-attack restoration engine, and other components. Large language models (LLMs) that can understand and generate human-like language and the associated generative AI-creating algorithms that can generate new content based on patterns learned from existing data are used to enhance cybersecurity measures across various aspects of the field. The LLMs can be AI algorithms that have been trained on a large amount of text-based data, typically scraped from the open internet such as webpages and sources such as scientific research, books, forums or social media posts. The generative AI logic can be an AI system (or portions thereof) configured to generate new content (e.g., images, music, speech, code, video, text, etc.). LLMs (e.g., GPT-3™, PaLM™, LLaMA™) can be the underlying technology behind many powerful generative AI systems today (e.g., ChatGPT™, Bard™).

The cybersecurity system uses one or more LLMs (and the associated generative AI-creating algorithms) that can generate new content based on patterns learned from existing data, such as in the following illustrative examples. As stated above, the AI-based cybersecurity system may be configured with an orchestration component implemented to include one or more LLMs operating to manage autonomous responses and provide context associated with the rationale for the autonomous responses (referred to as an “explanation”). The management of the autonomous response may include altering the severity of the response actions by increasing or decreasing the severity of the response actions.

Herein, the AI-based cybersecurity system can be implemented with an LLM positioned in front of the autonomous response engine to mitigate any potential cyber-attack and allow the autonomous response engine to make informed decisions as to what response(s) are to be conducted based in accordance with potential cyber-attack.

Additionally, or in the alternative, the orchestration component may be implemented with one or more LLMs operating as an orchestrator of (i) mitigation actions (e.g., remediation and/or mediation) and/or (ii) misconfiguration adjustment. The orchestration component, acting as an orchestrator of mitigation actions, is configured to restore/perform disaster recovery after detection of an on-going or successful cyber-attack. When acting as an orchestrator of misconfiguration adjustment, the orchestration component is configured to adjust settings for components within the AI-based cybersecurity system and/or computing devices protected by the cybersecurity system that may pose an entry point for a cyber-attack given the threat landscape.

The AI-based cybersecurity system can make use of LLMs that perform human language identification for automatic translation of content within the user interface, enabling localization and generation of suggested operations (in Natural Language Processing (NLP) format) needed to conduct mitigation and/or remediation to reduce risk in the cloud component and/or the general network environment. The LLMs of the cybersecurity system are configured to perform many additional tasks as discussed herein.

Thus, for example, the LLMs can be utilized to suggest remediation actions in the aftermath of cyber-attacks, aid in mitigating ongoing attacks by making informed decisions, function as first-line support for client queries, generate a perceived (i.e., displayed, audible playback, etc.) explanation of AI decision processes in cybersecurity platforms, summarize and prioritize breaches, assist in querying detailed log data, provide recommendations based on breach summaries and threat trends, generate code for data visualizations. By leveraging the capabilities of LLMs, organizations can strengthen their cybersecurity defenses and improve response mechanisms to counter advanced persistent threats effectively.

Thus, LLMs can be employed in conjunction with an autonomous response engine equipped with a Respond module (described below), enabling informed decision-making during an ongoing cyber-attack. This integration empowers organizations to swiftly mitigate the attack by leveraging the LLM's knowledge and expertise. Moreover, by training an LLM to act as a first line of support, clients can receive assistance in understanding cybersecurity products and troubleshooting issues they may encounter. Additionally, the LLM can provide valuable cyber analyst answers, shedding light on various cybersecurity techniques and the current threat landscape. Furthermore, organizations can harness the capabilities of LLMs by providing them with Application Programming Interface (API) specifications, enabling the LLM to understand how to make API requests and translate user questions into API queries within an AI-based cybersecurity platform. This functionality helps explain the decision-making process of the AI system, enhancing transparency and trust.

LLMs can also assist in analyzing cybersecurity breaches and their triggers by providing a summary and prioritization of these incidents based on available parameters. This aids in effective breach response and resource allocation. Additionally, training an LLM on the search syntax of tools (e.g., the cybersecurity appliance Advanced Search) enables users to query for detailed log data in a human-friendly manner, simplifying the process of extracting relevant information for investigations. By feeding an LLM with the history of cybersecurity breaches and model breaches, along with severity scores and current threat trends, the LLM can generate summaries and recommendations for users of cybersecurity appliances. This information empowers users to proactively improve their cybersecurity system's security posture in light of prevailing model breaches and emerging threat trends.

Furthermore, LLMs can be trained to generate software code that creates data visualizations, such as graphs and charts, showcasing cybersecurity breaches, user activity, current cyber threat trends, and/or actions needed and performed to combat a cyber threat based on the threat landscape data. This capability simplifies the presentation of complex data, enabling stakeholders to grasp key insights quickly.

In conclusion, through the utilization of LLMs, organizations can enhance their cybersecurity measures, effectively defend against cyber threats, and strengthen their overall resilience in the face of evolving cyber threats.

The advent of LLMs has opened up new possibilities in bolstering cybersecurity practices. For example, the cybersecurity system can use the LLM to suggest remediation actions to restore/perform disaster recovery after a cyber-attack by an advanced persistent threat. One such application lies in utilizing LLMs to suggest remediation actions for restoring and performing disaster recovery after cyber-attacks orchestrated by advanced persistent threats (APTs). By analyzing the attack vectors and understanding the intricacies of the breach, LLMs can provide valuable insights and guidance in recovering critical systems. In general, the cybersecurity system can use the LLM to recommend cloud remediation operations such as recommend cloud remediation steps.

The cybersecurity appliance, its cloud module, its SaaS module, and its autonomous response module can cooperate with the LLM to address any potential misconfigurations associated with components of the cybersecurity appliance or any modules in combination with the cybersecurity appliance. For example, the LLM can be used to recommend remediations for misconfigurations in a user's cloud account by asking questions such as the following: “I have an S3 bucket call production-sales-files-1′ that is open to the public, please give me steps to resolve this as well as an AWS-cli command and references.”

This same process could be applied to almost any ‘Alert’ within the cybersecurity system where the system provides the context and the recommended questions. As another example: A SaaS User in the platform “Box” has been seen logging in from an unusual IP address expected to be malicious, recommend steps to defend against this in the quickest possible way as well as references and hardening practices for the future.

Thus, the cybersecurity system can use the LLM to suggest remediation actions. More specifically, after a cyber-attack by an advanced persistent threat (APT) for example, an organization can leverage an LLM to suggest remediation actions. For example, the LLM can analyze the attack's characteristics, identify compromised systems or vulnerabilities, and provide recommendations on patching, system hardening, and security policy updates. It can offer specific steps to restore affected services and mitigate the risk of future attacks. By utilizing the vast knowledge base of an LLM, organizations can efficiently recover from cyber-attacks and strengthen their security posture.

The cybersecurity system can use an LLM in front of the autonomous response engine. Integrating an LLM in front of an autonomous response engine enables effective decision-making during an ongoing cyber-attack. The LLM can analyze real-time data from various sources, such as network logs, intrusion detection systems, and threat intelligence feeds to decide and/or alter response action to better detect and respond to detected incoming cyber threats as warned by the threat landscape data. Based on this information, the LLM can provide recommendations on containment measures, threat hunting strategies, or adjusting security controls. This collaborative approach empowers the autonomous response system to make informed decisions, accelerating the response time and minimizing the impact of the attack.

The cybersecurity system can use a LLM to make intelligent decisions by using the vast amounts of context we can provide. The more context we provide the better the decision. The more information about how the actions will work the better the choice.

For example, the following prompt:
The cybersecurity system has seen a login from a rare IP in Russia as well as regular events from Cambridge given the following possible actions <SET OF ACTIONS> which would be the best one to take. Explain why you made that decision.

The cybersecurity system can also pre-train the LLM on examples where malicious activity was successfully ended by Response actions, or on playbooks that exist for incident response, to assist in the decision making and recommendation.

### II. LLM Functionality

### A. Intelligent Search and API-LLM Explaining AI Decision Process in Cybersecurity Platforms

By providing an LLM with an API specification, organizations can enhance the transparency of AI-based cybersecurity platforms. The LLM can interpret user queries, translate them into API queries, and then explain how the AI-based cybersecurity system arrives at its decisions. This functionality enables users to understand the reasoning behind the capabilities of the AI-based recommendations or actions. It also helps build trust and confidence in the capabilities of the AI-based cybersecurity system, as users can gain insights into the decision-making process and validate the system's outputs.

By providing the LLM with an API specification an LLM can understand how to make API requests and translate questions into API queries.

The user interfaces into the different components of the cybersecurity system can use the AI to enhance how customers can interact with these products in natural language. This also allows for a natural language interaction with the cybersecurity product/platform. For example, a prompt may include “[g]iven our API docs find me all devices that communicated over TCP in the last 4 days.”

### B. Summarizing and Prioritizing Breaches

When provided with a list of model breaches and their triggers, an LLM can generate a summary and prioritize them based on specified parameters. For example, the LLM can consider the severity of the model breach, the impact on critical systems or data, and the potential risk to the enterprise. By prioritizing model breaches, organizations can allocate their resources more effectively, focusing on addressing the most critical incidents first. The LLM's analysis assists in streamlining breach response efforts and minimizing further damage as well as adjusting existing AI detection models and/or creating new AI detection models that would have uncovered the certain cyber threats or reduced over-breaching.

For example, as a prompt, the organization may provide the LLM with a list of all model breaches and their triggers then ask the LLM to provide a summary and prioritization of the breaches based on the parameters known about those breaches. For example, the prompt may state—“given there are 40 Breaches of moderate severity (e.g., score 60) for prescribed events that are new for the user, for users x, y, z at times a/b/c, provide me with a summary, any possible links between breaches, and also prioritize the order in which I should triage them.”

The LLM would be trained on the cybersecurity API and be aware of where information can be found, what kind of data each endpoint returns, and the data the cybersecurity AI Analyst considers relevant for similar activity.

### C. LLM Created AI Detection Model

The cybersecurity system can provide the LLM with a list of all statuses from cybersecurity modules and components (via APIs) and ask it to summaries the health of the deployment. On average we see traffic at a rate of 20000 events/s, then for example, 1 out of 20 SaaS modules have an error status and have been in that state for 2 weeks.

The LLM(s) may be configured to summarize the health of the deployed AI detection models and what can do to resolve “unhealthy” AI detection models.

### D. Natural Language Interface for the Cybersecurity Advanced Search

The cybersecurity system can query detailed log data in a human-speech way. Training an LLM on the search syntax for tools like the cybersecurity Advanced Search allows users to query detailed log data in a more user-friendly manner. Instead of learning complex search syntax, users can express their queries in natural language, making log analysis more accessible and efficient. The LLM understands the intent behind the query and translates it into the appropriate search syntax, simplifying the process of extracting relevant log information for investigations or threat hunting.

An LLM approach is trained on the search syntax for the cybersecurity Advanced Search, allowing users to query for detailed log data in a friendly human-speech way. This would be combined with training on the usual “questions” users ask—i.e., searches—to allow the interface to suggest the next steps in a friendly way.

### E. Producing Summary Reports and Recommendations

The cybersecurity system can provide breach summaries and recommendations. By feeding an LLM with historical cybersecurity breaches, severity scores, and current threat trends, organizations can generate breach summaries and receive recommendations. The LLM can analyze patterns, identify common vulnerabilities, or attack vectors, and provide actionable insights to improve system security. These recommendations can include implementing specific security controls, conducting vulnerability assessments, or enhancing user awareness through targeted training. The LLM's analysis empowers organizations to proactively strengthen their security defenses.

Supply an LLM the history of cybersecurity breaches/models breaches and their severity scores as well as current cyber threats trending currently (e.g., model breaches/respond/AI analyst) and have the LLM produce both a summary of these breaches and trends as well as to provide recommendations to help a user of a cybersecurity appliance to improve their system in light of the current model breaches and cyber threat trends. E.g., example prompts:
Prompt #1: Given that this month we have seen the following autonomous response actions: [block IP 1, block IP 2, block user 3, block user 4] produce me some security recommendations.
Prompt #2: An example might be to fully block certain IP ranges and conditional access policies to the users.
Prompt #3: Summarize John Boy's office365 SaaS events for the last week and decide if his current permissions set which is [X Y Z] is appropriate or whether they can be reduced.

### F. Produce Customized Data Visualizations

The cybersecurity system can generate code for data visualizations. Training an LLM to generate software code for creating data visualizations related to cybersecurity breaches, user activity, and threat trends can automate the process of generating informative visuals. The LLM can interpret the desired visualization requirements and generate code snippets in programming languages like Python™ or JavaScript™. This capability simplifies the creation of graphs, charts, or interactive dashboards, enabling security analysts and stakeholders to visualize and comprehend complex data in a more intuitive manner.

LLMs can retrieve data and write code, given a good enough specification. For an LLM pre-trained on the cybersecurity API, it can create (and implement) code to produce visualization based upon a natural language prompt. For example: “Produce me a bar graph that breaks down a user's activity over the last week, including sub-sections of the column breaking down the source IP.”

### III. Additional Ways Large Language Models (LLMs) Enhance Cybersecurity Measures Across Various Aspects of the Cybersecurity Field

Attack Simulation and Training Applications: The AI-based cybersecurity system can use LLMs to enhance cybersecurity measures by operating with the cyber-attack simulation engine to simulate attack scenarios and facilitate customized training. For example, LLMs can be trained on a user's style of email writing and formatting to generate plausible phishing emails in their “voice.” This approach can be utilized in cyber-attack simulation engine (PREVENT/E2E) engagements to create realistic phishing simulations and raise user awareness about potential threats. Additionally, LLMs can be employed to detect anomalies in email communication by comparing the actual emails with those predicted to be typical for a specific user. This comparison helps identify potentially malicious emails that deviate from the user's usual patterns.

Style transfer for emails to generate plausible phishing: Train an LLM on a user's style of email writing (including the underlying formatting) and use it to generate convincing phishing emails in their “voice” as part of PREVENT/E2E engagements.

Similarly, this can be applied as a detection approach—i.e., how much does this actual email differ from that which would be “predictable” for this user.

Generative use of a message passing neural network to simulate attacks: This form of the neural net is specialized to create graph structures. Therefore, it can be successfully trained on the graph structure of AI Analyst incidents in a customer environment and then used to generate convincing synthetic incidents for the purpose of simulating incident response, tailored to the client environment.

Using Auto GPT like LLMs to simulate attack scenarios: Another application involves using message passing neural networks specialized in creating graph structures. By training these neural networks on the graph structure of AI Analyst incidents in a customer environment, synthetic incidents can be generated. These synthetic incidents simulate real-world attack scenarios tailored to the client's environment, enabling organizations to simulate incident response and evaluate the effectiveness of their security measures.

Furthermore, LLMs like Auto GPT can be leveraged to simulate attack scenarios by working together and feeding back into themselves. The LLMs can work together and feed back into themselves to perform long complex tasks, as such, they can simulate a cyber-attacker in an environment. For example, an LLM agent placed on an isolated AWS EC2 instance can execute system commands to determine the operating system, make requests to check connectivity, and even attempt to exfiltrate information. The LLM agent on the EC2 instance follows the situation to exfiltrate key information and then as much information to a certain endpoint. The LLM agent on the EC2 instance uses system commands to work out what OS it is on, curl requests to check connectivity, if it knows it is on an AWS EC2 instance might make requests for credentials, etc.

This simulation provides organizations with insights into potential attack vectors and helps in refining their defensive strategies.

Intelligent Customized Training Scenarios: The cybersecurity system can use LLMs to generate long-form content customized to meet the specific needs of customers. By providing relevant information, such as connections blocked for suspicious websites or unusual file downloads, an LLM can create training plans and materials tailored to individual users. These materials can help users become more security aware and educate them about potential risks and best practices.

Thus, the LLMs can take prompts of what the system already knows about the organization and its users to produce long form content that is customized to be relevant to our customers' needs. The more info we can provide, the better the content will be. Customers can review the material before sending. For example, we can feed the LLM data from our modeling and RESPOND, e.g. Given that these users had connections blocked for dodgy websites, these users received the following bad emails, these users had unusual file downloads produce me a training plan and training materials for each user that I can send to help them become more security aware.

LLM-Driven Assistants for Third-Party Service Integration: Various kinds of LLM-driven “assistants” which submit e.g., AIA data to 3rd party services using a pre-engineered prompt.

LLMs can function as assistants that submit data to third-party services using pre-engineered prompts. For instance, an LLM can be prompted to query OSINT (Open-Source Intelligence) tools or a customer's threat intelligence tools by connecting to their APIs. Thus, the LLM is pre-prompted to query services like OSINT tools or the customer's own data lakes/threat intel tools, using an understanding of how to connect to their APIs. This enables, for example, the LLM-driven assistant to provide information by checking Al Analyst data against services like Microsoft Defender or obtaining insights from tools like VirusTotal. The chatbot/assistant implementation can then be asked things like “Check this AI Analyst information against Microsoft Defender?” or “What does VirusTotal think about this endpoint?”

Training an LLM on web responses and certificate information, and using the resulting embeddings to search for similar services: The LLM is trained on certificate information and responses (almost akin to a JA3 or similar attempts to “fingerprint”), then is fed data from the wider web to try and find examples of the same service it was trained on (i.e., that fit its predication).

The cybersecurity system can make use of intelligent user combinations across platforms (e.g., combining users with similar usernames or presences across different platforms). LLMs can assist in this process by considering contextual data, such as roles, activity times, standard behaviors, and clustered peers. By providing all available information about both users, the LLM can assess whether it is appropriate to combine them or not. This capability extends to devices by considering factors such as hostnames, active times, and locations. LLMs have the advantage of being able to process vast amounts of time-series data and make informed decisions, which can then be corrected by human input if necessary.

The system can combine users with similar usernames or presences back into a single user, when appropriate, without a human indicating they are the same. For example, is john@slammar the same user as john.b@slimmer, Or are they two users with the same initials?

In an example, the system feeds the LLM all contextual data available about both users (including roles, activity times, standard behaviors, clustered peers, etc.) and then let the LLM assess whether it would be a good idea to combine them or not.

This can be extended to devices by considering hostnames, active times, and locations—the power comes from it being able to use any information (e.g., vast amounts of time series data a human cannot comprehend) and decide which it cares about. If it is wrong, then a user can just tell it so and correct the output.

Full Translations within the Platform: LLMs can be employed for the automatic translation of content within the user interface, enabling localization. This feature is particularly useful for user comments, email content, or other non-hard-coded text. For example, an LLM can be used to translate emails, button texts, team messages, event types, or analyst comments into various languages, enhancing accessibility and facilitating effective communication across language barriers. Thus, for example:
1) Translate this email so that my Spanish team can work on it;
2) Translate all the button texts to French;
3) Translate this Teams message to Spanish;
4) Translate all the SaaS event types; and
5) Translate this analyst's comment into my language.

By leveraging these additional capabilities of LLMs, organizations can enhance their cybersecurity measures, improve user training, simulate realistic attack scenarios, integrate with third-party services, facilitate user data analysis, and enable multilingual functionality within their platforms.

The cyber threat detection engine (along with the AI-based cybersecurity analyst), the cyber threat autonomous response engine, the cyber-attack simulation engine and the cyber-attack restoration engine can continuously monitor for and autonomously respond to (i.e., block or alert security teams) activity from employees accessing or sending specific types of data to these tools, which will help security teams who are restricting certain use or requiring permissions for employees to use these tools.

The AI-based cybersecurity analyst can use a transformer-based LLM classifier to assist the cyber threat detection engine, the cyber threat autonomous response engine, the cyber-attack simulation engine, and the cyber-attack restoration engine to detect and mitigate cyber threats. The transformer-based LLM classifier can categorize malicious communications based on textual properties. This is used in analysis of natural language content, such as phishing links, to provide context to inoculation hits. The transformer-based large language model classifier can be trained specifically on security data, as part of the core functionality. Furthermore, the AI-based cybersecurity analyst now uses an enhanced transformer-based LLM that has been trained on security network and engineering data so that it can better identify anomalous behavior, services, and endpoints. This also enables the AI-based cybersecurity analyst to provide even more context of a cyber threat to human analysts. Also, the cyber-attack simulation engine can perform attack path validation with the use of LLM generated attacks in addition to other Natural Language processed derived attacks. The cyber-attack simulation engine can perform intelligent APT targeting analysis, reporting, and refreshed CVE visualization. Thus, the Attack Path Validation portion can bring LLM-generated attack capabilities alongside existing NLP-derived attack engagements. This allows the cyber-attack simulation engine to emulate attacks in a wider range of sophistication and complexity to meet customer needs. For example, the LLM generated attack capabilities were added to cyber-attack simulation engine because in some scenarios the attacks emulated using the NLP models were actually too convincing/sophisticated and customers/users wanted there to be a way to have more basic/recognizable fake cyber-attacks (which is what the LLM-generated models are better at—they meet the need for there to be slightly more generalized, less personalized scenarios). Thus, the cyber-attack simulation engine can use generative AI logic to, for example, enhance the creativity, relevancy, and precision of simulated phishing attacks for security training.

The user interface to the cyber threat autonomous response engine presents options on a Quick Setup process to add a greater visibility over the autonomous state of the cyber threat autonomous response engine, with accompanying alerts.

Next, the cybersecurity system can train those LLMs with factors such as (what data are they trained on, how was the data selected or cleaned of offensive, inaccurate, or biased data, how is it safeguarded, etc. The cybersecurity system uses a variety of different data sources and techniques to train its AI models. For example, the enhanced transformer-based LLM classifier can be trained on inoculation data (which is anonymized breaches and methods submitted by customers) as well as additional research data. The AI-based cybersecurity analyst includes models trained on millions of interactions between human cybersecurity expert analysts and the other components making up the cybersecurity system so that it can emulate human thought processes and continuously investigate cyber-threats behind the scenes at machine speed. This allows a diverse approach so that there is no one-size-fits-all approach when it comes to the AI approaches.

The cybersecurity system uses a variety of different types of AI across the components in this system, which includes unique self-learning AI models that understand the nuance of each customers' particular network composition and business operations as well as generative AI logic, large language models, natural language processing models, supervised learning models, and much more.

### IV. AI-Based Cybersecurity Analyst

The AI-based cybersecurity analyst is a module that utilizes generative AI logic to augment threat analysis and investigations to handle threat investigations at machine speed and scale. The AI-based cybersecurity analyst is trained on millions of interactions between the human cybersecurity analysts and the components of the cybersecurity system so that it can emulate human thought processes and continuously investigate cyber-threats behind the scenes. The AI-based cybersecurity analyst brings forward the highest priority threats for human investigation, providing explanations and context so that your teams have access to relevant details, device information and dates from the start and do not waste time querying the system looking into low priority incidents. This is made possible by many different types of AI, including self-learning AI that understands your unique business patterns of life, as well as other types of AI models including large language models that bring more context to the investigations. In general, the components of the cybersecurity system use different types of AI. The components of the cybersecurity system apply the right type of AI to the right use cases, and use many different types of AI to address the multitude of challenges facing cybersecurity teams today.

The AI-based cybersecurity analyst can use a LLM that can understand human language, language like data, and parameters to make an analysis and can then generate text or take other action based on the analysis. The AI-based cybersecurity analyst and/or cyber threat detection engine can also have some integrations with other generative AI tools such as ChatGPT™, including a tool which will allow customers to monitor whether their employees are accessing ChatGPT™ and whether that contravenes the customer's internal policies.

The AI-based cybersecurity analyst and/or the cyber threat detection engine can have a natural language interface that will enable every user, regardless of experience level or organization size, to take full advantage of the capabilities of that tool—AI-based cybersecurity analyst and/or cyber threat detection engine. The AI-based cybersecurity analyst tool leverages state-of-the-art NLP techniques to understand and interpret human language in a cybersecurity context. The AI-based cybersecurity analyst tool utilizes machine learning algorithms and neural networks to process and analyze vast amounts of textual data, allowing it to extract meaningful insights and patterns. By comprehending human language, the tool can effectively interact with users, making it accessible to individuals with varying levels of experience and expertise in cybersecurity.

The AI-based cybersecurity analyst tool helps human cybersecurity personnel to ask simple, straightforward questions, and then the AI-based cybersecurity analyst tool provides real-time insight into an organization's risk profile, including its threat landscape, risk level against critical vulnerabilities, current security posture, compliance requirements, cybersecurity performance metrics and much more.

The AI-based cybersecurity analyst tool helps human cybersecurity personnel to better understand the threats and risks facing their organization. The AI-based cybersecurity analyst tool also helps Security Analysts make better decisions for cyber threat hunting faster, reducing response time to critical incidents. The AI-based cybersecurity analyst tool provides basic information such as which threat actors are targeting that network, what are the critical vulnerabilities being exploited by these adversaries, what are the top recommended remediation actions for the impacted endpoint, etc.

Thus, in terms of functionality, the AI-based cybersecurity analyst tool provides a wide range of capabilities to support cybersecurity personnel in their day-to-day operations. One of the AI-based cybersecurity analyst tool's primary roles is to assist in risk assessment by answering questions and providing real-time insights into an organization's risk profile. This includes assessing the threat landscape by identifying potential adversaries and their tactics, evaluating the organization's risk level against critical vulnerabilities, and assessing the overall security posture.

Furthermore, the AI-based cybersecurity analyst tool aids security analysts in making informed decisions for cyber threat hunting. The AI-based cybersecurity analyst tool equips human security analysts with the necessary information to proactively identify and mitigate potential security incidents. By analyzing data from various sources, such as network logs, intrusion detection systems, and threat intelligence feeds, the tool can highlight indicators of compromise (IOCs) and provide recommendations for remediation actions. This empowers security analysts to respond swiftly to critical incidents and minimize the impact on the organization.

To streamline security operations, the AI-based cybersecurity analyst tool automates repetitive and mundane tasks, enabling analysts to focus on more critical and complex activities. The AI-based cybersecurity analyst can handle data collection and extraction from multiple sources, reducing the manual effort required to gather relevant information for analysis. Additionally, the tool performs basic threat searches and detection, leveraging its understanding of threat intelligence and historical attack patterns to identify potential security threats.

The AI-based cybersecurity analyst tool as a Large language model (LLM) is built to incorporate cyber threat knowledge from external data stores, external data sources, as well as from a network's own cybersecurity appliance. The AI-based cybersecurity analyst tool uses threat intelligence to understand a cyber threat adversary tactics and motivations. The effectiveness of the AI-based cybersecurity analyst tool lies in its ability to access and integrate diverse data sources. The AI-based cybersecurity analyst can tap into external data stores, such as threat intelligence platforms and vulnerability databases, to enrich its understanding of the threat landscape. Additionally, the tool leverages data from an organization's internal cybersecurity appliance, an intrusion prevention simulator system, and endpoint protection solutions, to gain insights into the specific threats and vulnerabilities faced by the organization. This combination of external and internal data sources allows the AI-based cybersecurity analyst tool to provide a holistic view of the organization's security posture.

Through continuous improvement and refinement, the AI-based cybersecurity analyst tool ensures that it remains up-to-date with the evolving cybersecurity landscape. It collaborates closely with industry-leading cyber threat hunters, managed detection and response operators, and incident response experts to incorporate their expertise and insights into its analysis. This feedback loop helps enhance the tool's accuracy and effectiveness, enabling it to adapt to emerging threats and new attack vectors.

In addition to its technical capabilities, the AI-based cybersecurity analyst tool facilitates human-machine collaboration to tackle the challenges posed by adversaries. By leveraging the speed and computational power of AI, combined with human expertise and intuition, security teams can gain a significant advantage. The tool serves as a force multiplier, augmenting the capabilities of security analysts and enabling them to detect and respond to threats more efficiently.

The AI-based cybersecurity analyst tool understands the importance of adaptability and agility in the face of evolving threats. The AI-based cybersecurity analyst tool employs advanced analytics to prioritize critical vulnerabilities and potential risks, enabling organizations to allocate their resources effectively. By generating and validating new indicators of attack (IOAs), the tool aids in the identification of emerging attack patterns, empowering security teams to proactively defend against evolving threats.

Ultimately, the AI-based cybersecurity analyst tool recognizes that effective cybersecurity requires a combination of AI-driven analysis and human intelligence. The AI-based cybersecurity analyst tool can incorporate human insight into the investigative loop. The AI-based cybersecurity analyst tool tracks the adversaries that are constantly innovating and adapting their tactics, and incorporates human expertise and insights into the training data used by the models in the AI-based cybersecurity analyst tool. By blending the strengths of AI and human intelligence, organizations can stay ahead of the threat landscape and proactively defend against emerging cyber threats. The adversary is constantly breaking rules and changing tactics, making it hard for AI to respond without the right data to train the model. This is why human-validated content is critical for AI to perform security use cases and give security teams the advantage over adversaries.

### V. Additional AI Concepts

One embodiment of the disclosure is directed towards scraping many common news and information sources and using one of these machine learning tools to build up a regularly updating database of existing malware, its impact, the wider community perception of it, the patterns of infection that it follows, the symptoms of infection, the entry routes it might take. By cross referencing multiple sources, we can build levels of confidence in our stored data to ignore erroneous reports.

The second part suggested is building a pattern of life for malicious organizations to make predictions on who will be impacted, at what level and to what extent a company should be worried about it. This may involve conducting analytics on the patterns of mercenary APTs publicly claimed victims (and statements from the APT groups), the political landscape, dark web content, company age/history/exposure and the general atmosphere/consensus of the hacking scene. This would be content analysis on dark web pages and on social media.

This information can be used to increase priority warnings for specific industry verticals or activity types. For example, autonomous response actions on “fashionable” approaches can be more stringent. Autonomous response actions to mitigate a cyber threat reactivity on customers known to sit within targeted verticals can be increased.

### VI. AI-Based Cybersecurity System Architecture

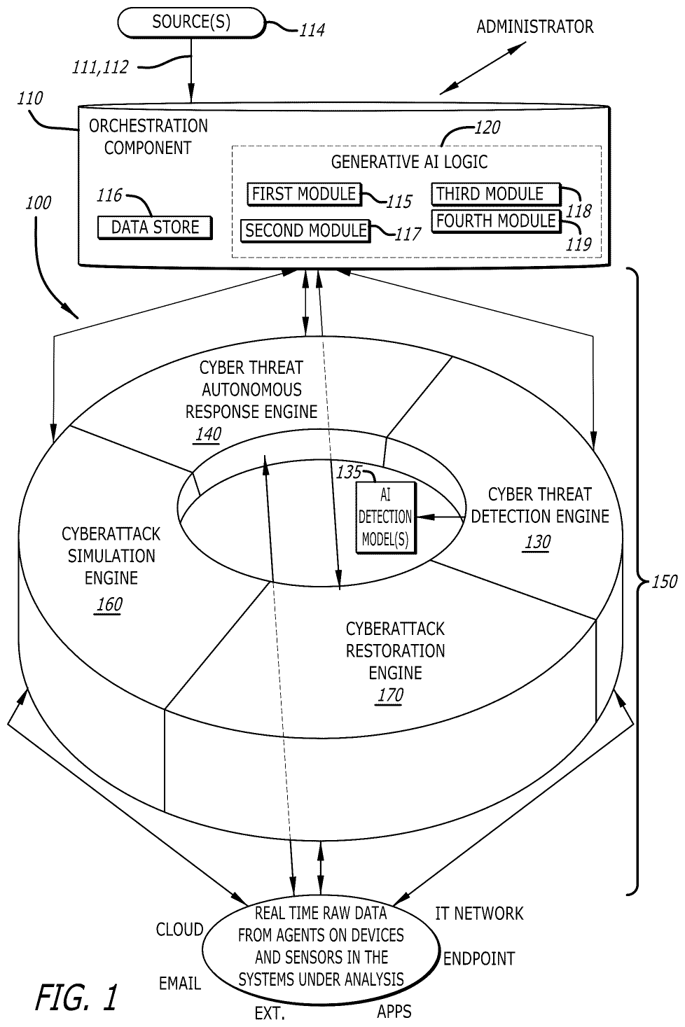

Referring to FIG. 1, an illustrative embodiment of an AI-based cybersecurity system 100 is shown. The AI-based cybersecurity system 100 features an orchestration component 110, which configured to utilize generative Artificial Intelligence (AI) logic 120 including one or more Large Language Models (LLMs) to influence reactive operations (e.g., cyber threat detection and response) as well as proactive operations (e.g., risk mitigation and misconfiguration). As an illustrative example, the orchestration component 110 is configured to utilize the one or more LLMs that (i) influence actions performed by certain logic (engines), (ii) provide explanations in a NLP format directed to the influenced actions, and (iii) identify device configuration and operability where adjustments may improve security of a computing device or network protected by the AI-based cybersecurity system 100, and (iv) provide explanations in a NLP format the benefits and/or adjustments recommended to improve device/network security. Herein, the orchestration component 110 may be configured to influence at least a cyber threat detection engine 130 and a cyber threat autonomous response engine 140 deployed within an AI-based cybersecurity appliance 150 as shown.

More specifically, the orchestration component 110 is configured to receive and/or extract unstructured information 111 associated with a current cyber threat detected externally from the AI-based cybersecurity system (hereinafter, the “threat landscape information”). The threat landscape information 111 associated with the threat landscape is received from one or more sources 114 external from the AI-based cybersecurity system 100 such as open source cyberthreat intelligence, social media information, and/or news website information for example. Herein, according to this embodiment of the disclosure, the orchestration component 110 includes a first module 115 that conducts analytics on the threat landscape information 111 to identify and extract salient data associated with cyber threats associated with the current threat landscape (e.g., threat actor, targeted industries, targeted geographic regions, etc.) and/or data associated with one or more techniques deployed for the current cyber threat to breach a targeted destination such as an enterprise network or a computing device (collectively, “threat technique data”). Thereafter, the (current) threat technique data 112 is stored within a data store 116 accessible by the orchestration component 110.

The orchestration component 110 further includes a second module 117, which is accessible to both the data store 116 and a third module 118 configured to communicate with the cyber threat detection engine 130 to retrieve information associated with on-going cyber threat detections. The second module 117 is configured to determine the presence of an AI model that may be used to conduct analytics on incoming, monitored data to detect whether a cyber-attack (e.g., AI model breach) has occurred or is being attempted in accordance with one of the current threat techniques represented by the threat landscape information and maintained within the data store 116. The data store 116 operates as a rolling window to retain threat landscape information that is relevant on a temporal basis.

The second module 117 may be configured to generate a first message (hereinafter, “first severity score”), which may be used to enhance the likelihood by the AI model detecting the current cyber threat. The first severity score message may be used to adjust the sensitivity of the cyber threat detection engine 130 in (i) detecting events (observable occurrence representing system or device behavior) consistent with a current threat technique for a cyber threat that is prevalent in the global threat landscape and/or (ii) alerting an administrator that monitored data may constitute the current cyber threat.

For event detection, when the monitored cyber threat activity received from the third module 118 is correlated with cyber threat activity identified in the threat landscape information, the second module 117 may generate the first severity score message to enhance threat detection for this particular cyber threat activity. According to one embodiment of the disclosure, this may involve reducing a level of correlation (detect threshold) associated with one or more AI models utilized by the cyber threat detection engine 130 in analyzing the monitored cyber threat activity in order to better detect a series of events within the monitored data that are consistent with a current threat technique uncovered by the threat technique data 112. As a result, the reduced detect threshold may cause the cyber threat detection engine 130 to issue alerts more readily.

Similarly, where the current cyber threat is becoming less pervasive based on the cyberthreat landscape information, the second module 117 may generate the first severity score message to reduce threat detection focus for this particular cyber threat activity. In contrast to the operations described above, the reduced severity score may adjust threat detection operability by increasing the detect threshold, where the increased detect threshold may require more definitive evidence of a potential cyber threat before the cyber threat detection engine 130 issues an alert.

According to one embodiment of the disclosure, additionally or in the alternative, the adjustment of the sensitivity of the cyber threat detection engine 130 may be accomplished through administrator alerts generated for display on a graphic user interface (GUI). For example, the adjustment of threat detection operability may be accomplished by adjusting the alert notification scheme through visual enhancement of the alerts (e.g., prioritizing order of alerts with alerts identified in the threat landscape information given higher priority, adjusting display location of the alert, changing a visual rendering of the alert (e.g., changing font, font color, font size, etc.)), activating one or more additional alert delivery schemes (e.g., text alert, audio notification, etc.), or the like.

As an illustrative example, the threat technique data 112 may include events that identify that particular ransomware actors are actively targeting a particular industry, geographic location, particular type of technology (e.g., devices with certain operating system types, certain computing device types, etc.), or the like. As a result, the orchestration component 110 may generate the first severity score message to signal enhanced operability by the cyber threat detection engine 130 such as utilizing a prescribed AI model trained to monitor incoming network data for domains including those domains reportedly utilized with the ransomware actor, monitor for incoming network data targeted for updating a certain OS type, etc. Additionally, or in the alternative, the orchestration component 110 may be configured to signal the cyber threat detection engine 130 to install an AI model that may detect a particular type of ransomware identified by the threat technique data 112 better than any AI models accessible to the cyber threat detection engine 130.

As described above, the orchestration component 110 may be configured to include the third module 118 that provides the first severity score message to adjust operability of the cyber threat detection engine 130. Additionally, the orchestration component 110 may be configured to include a fourth module 119, which is adapted to communicate with the cyber threat autonomous response engine 140 to retrieve information associated with on-going actions in response to detected cyber threats (hereinafter, “response actions”). More specifically, the second module 117 is configured to conduct analytics between the response actions acquired from the fourth module 119 and information associated with the current threat techniques stored within the data store 116 to potentially increase severity of the actions performed in response to detection of the current cyber threat based on information included within a second severity score message from the second module 117. For example, an increased severity score (e.g., greater than a default score) included in the second severity score message may prompt the autonomous response engine 140 to conduct more aggressive actions (e.g., quarantine, block communications between components or computing devices, revoke permissions, shut down a computing device or series of computing devices, etc.) in response to detection of a potential cyber-attack involving the current cyber threat.

Likewise, the second module 117 may be configured, additionally or in the alternative, to conduct analytics between the response actions acquired from the fourth module 119 and information associated with the current threat techniques stored within the data store 116 to potentially increase severity of the response actions through additional response action or different response actions being conducted. For example, the second module 117 may configure the autonomous response engine 140 to conduct additional response actions for particular cyber threat type represented by the threat landscape technique data 112, besides a regular set of response actions being performed. A decreased severity score may prompt the autonomous response engine 140 to conduct the regular set of response actions or eliminate one of more of these response actions (e.g., no blockage, just quarantine data and log).

The autonomous response engine 140 is configured to utilize AI algorithms configured and trained to perform a second machine-learned (ML) task of taking one or more mitigation actions to mitigate the cyber threat. The autonomous response engine 140 is communicatively coupled to the orchestration component 110 to receive the detected severity score that, depending on the adjustment, may cause certain response actions (or extra response actions) to be conducted on the monitored data. In summary, the increased severity score may further cause an increase in the utilization of additional cyberthreat analytic tools and/or conducting additional and/or more severe response actions to better mitigate or eliminate a potential cyber threat. The decreased severity score may cause an opposite effect.

Additionally, the orchestration component 110 may be further configured to communicate with the cyber-attack simulation engine 160 and the cyber-attack restoration engine 170. The cyber-attack simulation engine 160 is configured, using AI algorithms coded and trained to perform a ML task of AI-based simulations of cyber-attacks to assist in determining 1) how a simulated cyber-attack might occur in the AI-based cybersecurity system 100 being protected, and 2) how to use the simulated cyber-attack information to preempt possible escalations of an ongoing actual cyber-attack. The cyber-attack restoration engine 170 is configured to use AI algorithms configured and trained to perform a third machine-learned task of remediating the AI-based cybersecurity system 100 being protected back to a trusted operational state.

The cyber-attack restoration engine 170 is configured to conduct actions to fix one or more cloud components for the AI-based cybersecurity system 100 thereby adjusting for any misconfigurations associated with these component(s). This may include altering settings, permissions, or stored information (e.g., addressing, data, etc.) within the component(s) or even returning the component(s) back to their trusted operational state. These remediation actions might be fully automatic, or require a specific human confirmation decision before they begin. The cyber-attack restoration engine 170 is further configured to cooperate with the other AI-based engines of the cybersecurity appliance 150, via interfaces and/or direct integrations, to track and understand the cyber threat identified by the threat technique data 112 and the other components as well as track the one or more actions to be undertaken to fix the misconfiguration or to assist in intelligently restoring the protected system while still mitigating the cyber threat attack back to a trusted operational state. Thus, as a situation develops with an ongoing cyber-attack, the cyber-attack restoration engine 170 is configured to take one or more actions to remediate (e.g., address misconfiguration or restore) components associated with the AI-based cybersecurity system 100 to a trusted operational state while the cyber-attack is still ongoing.

In summary, multiple AI-based engines, cooperating with each other, may include i) the cyber threat detection engine 130, ii) an autonomous response engine 140, iii) the cyber-attack simulation engine 160, and iv) the cyber-attack restoration engine 170. The multiple AI-based engines have communication hooks in between them to exchange a significant amount of behavioral metrics including data between the multiple AI-based engines to work in together to provide an overall cyber threat response.

The orchestration component 110 can be configured as a discreet intelligent component that exists on top of the multiple AI-based engines 130, 140, 160 and 170 to orchestrate the overall cyber threat response and an interaction between the multiple AI-based engines, each configured to perform its own machine-learned task. Alternatively, the orchestration component 110 can be configured as a distributed collaboration of the functionality of the orchestration component 110 being implemented in each within multiple AI-based engines to orchestrate the overall cyber threat response and/or detection. In an embodiment, whether implemented as a distributed portion on each AI engine or a discrete AI engine itself, the orchestration component 110 can use self-learning algorithms to learn how to best assist the orchestration of the interaction between itself and the other AI-based engines, which also implement self-learning algorithms themselves to perform their individual machine-learned tasks better.

The multiple AI-based engines can be configured to cooperate in combination that results in an understanding of normal operations of the components, an understanding emerging cyber threats, an ability to contain those emerging cyber threats, and a restoration of the components of the AI-based cybersecurity system to heal the system with an adaptive feedback between the multiple AI-based engines in light of simulations of the cyber-attack to predict what might occur in the components in the AI-based cybersecurity system based on the progression of the attack so far, mitigation actions taken to contain those emerging cyber threats and remediation actions taken to heal the nodes using the simulated cyber-attack information.

One or more AI models in the cyber threat detection engine 130 can be configured to maintain what is considered to be normal behavior for that node, which is constructed on a per node basis, on the system being protected from historical data of that specific node over an operation of the system being protected.

The multiple AI-based engines each have an interface to communicate with the other separate AI-based engines configured to understand a type of information and communication that the other separate AI-based engine needs to make determinations on an ongoing cyber-attack from that other AI-based engine's perspective. Each AI-based engine has an instant messaging system to communicate with a human cyber-security team to keep the human cyber-security team informed on actions autonomously taken and actions needing human approval as well as generate reports for the human cyber-security team.

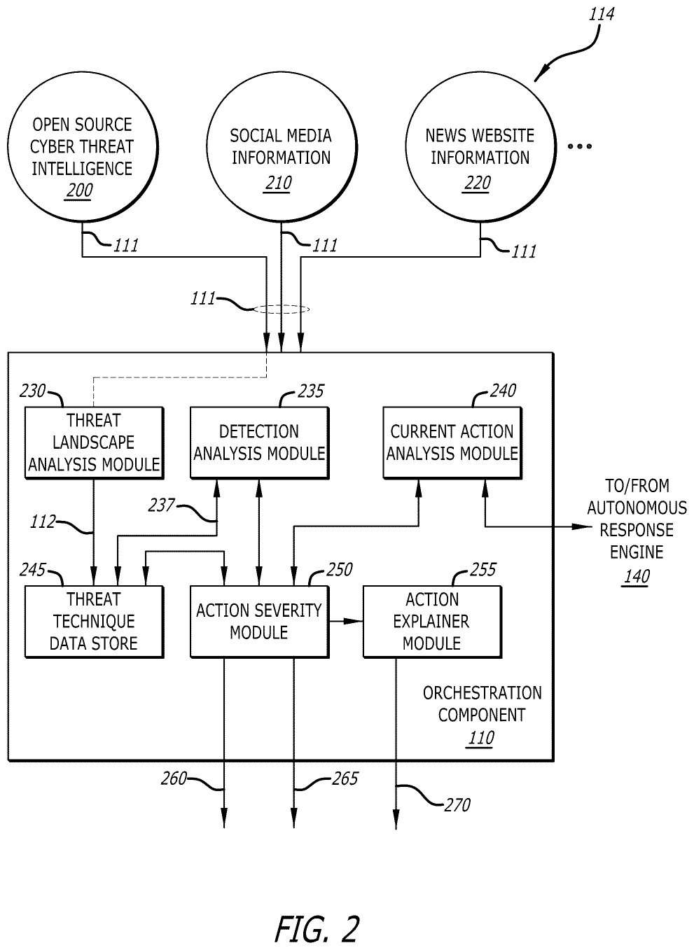

Referring now to FIG. 2, an illustrative embodiment of the orchestration component 110, in communication with external sources 114 for receipt of threat technique data 112, configured to control operability of the cybersecurity appliance 150 is shown. The cybersecurity appliance 150 features the cyber threat detection engine 130, the cyber threat autonomous response engine 140, the cyber-attack simulation engine 160, and the cyber-attack restoration engine 170.

More specifically, the orchestration component 110 is configured to receive content associated with the threat landscape from different sources 114 including, but not limited or restricted to the following: (i) open source cyberthreat intelligence 200, (ii) social media information 210, and/or (iii) news website information 220. Herein, according to this embodiment of the disclosure, as shown in FIGS. 1-2, the orchestration component 110 includes a threat landscape analysis module 230 (e.g., first module 115 of FIG. 1), a detection analysis module 235 (e.g., third module 118 of FIG. 1), a current action analysis module 240 (e.g., fourth module 119 of FIG. 1), a threat technique data store 245 (e.g., data store 116 of FIG. 1), an action severity module 250 (e.g., second module 117 of FIG. 1), and an action explainer module 255. According to one embodiment of the disclosure, the threat landscape analysis module 230, the detection analysis module 235 and the action explainer module 255 are configured as LLMs to perform operations described below or include access to a LLM or dedicated LLMs.

As shown in FIG. 2, the orchestration component 110 is configured to utilize the one or more LLMs, which are configured to influence actions performed by certain logic (engines) within the cybersecurity appliance 150 such as the cyber threat detection engine 130, the cyber threat autonomous response engine 140, the cyber-attack simulation engine 160, and the cyber-attack restoration engine 170. The orchestration component 110 is further configured to utilize the one or more LLMs, deployed as part of or accessible to the threat landscape analysis module 230, to conduct LLM-based analysis of the threat landscape content 200/210/220 (e.g., rich text analytics) to produce the threat technique data 112. The threat technique data 112 identifies the techniques and tools associated with cyber threats identified within the threat landscape content 200/210/220.

The orchestration component 110 is further configured to utilize the one or more LLMs, deployed as part of or accessible to the action explainer module 255, to generate explanations 270 in an NLP format directed to why response actions are being conducted and/or why the severity of the response actions has been increased, decreased, or remains the same.

More specifically, the threat landscape analysis module 230 is configured to extract the threat technique data 112 from the threat landscape information 111 received from one or more sources 114, where the threat landscape information 111 pertains to data associated with techniques and/or tools utilized by current cyber threats detected externally from the AI-based cybersecurity system. The threat landscape analysis module 230 is configured to conduct analytics on the threat landscape information 111 to identify and extract the threat technique data 112, namely salient data associated with cyber threats associated with the current threat landscape (e.g., threat actor, targeted industries, targeted geographic regions, etc.) and/or data associated with one or more techniques deployed for the current cyber threat to breach a targeted destination such as an enterprise network or a computing device. Thereafter, the threat technique data 112 is stored within the threat technique data store 245 accessible by the detection analysis module 235 and/or the action severity module 250.

The action severity module 250 is communicatively coupled to the detection analysis module 235, the current action analysis module 240, the threat technique data store 245, and the action explainer module 255. Herein, the action severity module 250 is configured to communicate with the detection analysis module 235 and retrieve information associated with detected on-going cyber threats. This retrieved information may include identifiers of one or more AI models utilized by the cyber threat detection engine 130 to conduct analytics on incoming, monitored data to detect whether a cyber threat, such as cyber-attack (e.g., AI model breach) for example, has occurred. The retrieved information may also include information associated with the events that pertain to cyber threats, which are detected by the cyber threat detection engine 130 or are being attempted in accordance with one of the threat techniques represented by the threat technique data 112 maintained within the threat technique data store 245. The threat technique data store 245 operates as a rolling window thereby storing threat landscape information for a prescribed period of time (e.g., a few hours, a day, a few days, a week or even a few weeks).

The action severity module 250 may be configured to generate a first severity score message 260, which may be used to adjust the sensitivity of the cyber threat detection engine 130 in detecting events consistent with a threat technique for a cyber threat that is prevalent in the threat landscape and/or alerting an administrator that monitored data may constitute the current cyber threat.

For event detection, when the monitored cyber threat activity received from the detection analysis module 235 is correlated with cyber threat activity identified in the threat technique data 112, the action severity module 250 may generate the first severity score message 260 to enhance (i.e., increase sensitivity of) threat detection for this particular cyber threat activity. According to one embodiment of the disclosure, this first severity score message 260 may involve reducing a level of correlation (detect threshold) associated with one or more AI models utilized by the cyber threat detection engine 130 in analyzing monitored data for cyber threat activity in order to better detect a series of events within the monitored data that are consistent with one or more of the threat technique uncovered by the threat landscape analysis module 230. As a result, the reduced detect threshold may cause the cyber threat detection engine 130 to issue alerts more readily.

Similarly, where the current cyber threat is becoming less pervasive as represented by the threat technique data 112, the action severity module 250 may generate the first severity score message 260 adapted to decrease the cyber threat detection sensitivity by at least reducing threat detection focused on this particular cyber threat activity. In contrast to the operations described above, the reduced severity score may adjust threat detection operability by increasing the detect threshold, where the increased detect threshold may require more definitive evidence of a potential cyber threat before the cyber threat detection engine 130 issues an alert.

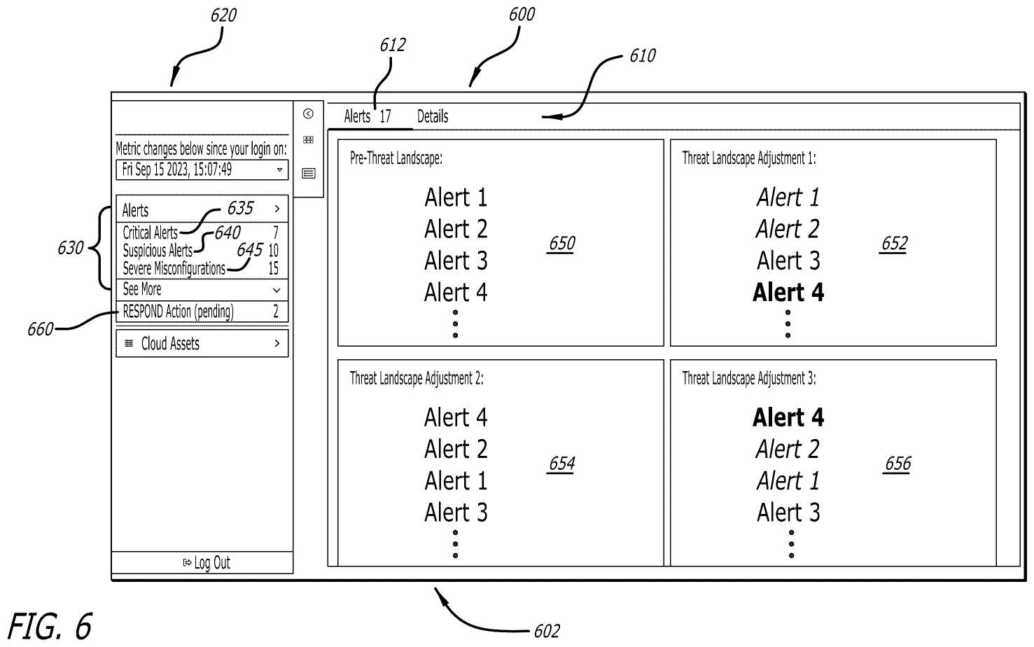

According to another embodiment of the disclosure, additionally or in the alternative, the action severity module 250 may generate the first severity score message 260 to adjust the sensitivity of the cyber threat detection engine 130 in its issuance of administrator alerts. For instance, the first severity score message 260 may include information to cause the cyber threat detection engine 130 to adjust its alert notification scheme, which may include adjusting the visual representation of the alert on a dashboard (see FIG. 6). As an illustrative example, the first severity score message 260 may include information that causes the cyber threat detection engine 130 to prioritize order of alerts differently, with alerts associated with cyber threats identified in threat technique data 112 given higher priority. As another illustrative example, the first severity score message 260 may include information that causes the cyber threat detection engine 130 to adjust display location of these threat landscape-based alerts, changing a visual rendering of these alert (e.g., changing font, font color, font size, etc.)), activating one or more additional alert delivery schemes (e.g., text alert, audio notification, etc.) to notify the administrator of these threat landscape-based alerts, or the like.

As further shown in FIG. 2, the action severity module 250 is configured to communicate with the current action analysis module 240 and retrieve information associated with detected response actions being conducted by the autonomous response engine 140. As shown, the current action analysis module 240 is communicatively coupled to the autonomous response engine 140 and is adapted to obtain the response actions therefrom. Thereafter, in response to determining that the monitored response actions received from the detection analysis module 235 is correlated to actions for handling cyber threat activity identified by the threat technique data 112, the action severity module 250 generates a second severity score message 265 that may increase the severity of the response actions conducted by the autonomous response engine 140 to combat the cyber threat(s). For example, an increased severity score may be selected based on analysis of the response actions currently being performed to notify the autonomous response engine 140 to conduct more aggressive actions in response to the detected cyber threat.

For example, the current response actions may identify a log event or a quarantine event. An increased severity score may be selected by the action severity module 250 to alter operability of the autonomous response in responding to all types or particular types of cyber threats (e.g., cyber-attack involving the current cyber threat technique) by blocking communications, revoke permissions, or even shut down a computing device. These response actions represented by the increased severity score may involve the substitution of the regular set of response actions being performed or the performance of additional response actions for particular cyber threat type represented by the threat landscape information.

A decreased severity score may prompt the autonomous response engine 140 to conduct the regular set of response actions or eliminate one of more of these response actions (e.g., no blockage, just log data, not quarantine, etc.).

Additionally, although not shown, the threat technique data store 245 may be further configured to communicate with the cyber-attack simulation engine 160 and the cyber-attack restoration engine 170 of FIG. 1. The cyber-attack simulation engine 160 is configured, using AI algorithms coded and trained to perform a ML task of AI-based simulations of cyber-attacks to assist in determining 1) how a simulated cyber-attack might occur in a selected computing device protected by the AI-based cybersecurity system 100, and 2) how to use the simulated cyber-attack information to preempt possible escalations of an ongoing actual cyber-attack. The cyber-attack restoration engine 170 is configured to use AI algorithms configured and trained to perform a third machine-learned task of remediating the AI-based cybersecurity system 100 being protected back to a trusted operational state.

According to one embodiment of the disclosure, the cyber-attack restoration engine 170 is configured to conduct one or more remediation actions to remediate one or more components of the AI-based cybersecurity system 100 thereby taking the one or more components back to their trusted operational state. These remediation actions might be fully automatic, or require a specific human confirmation decision before they begin. The cyber-attack restoration engine 170 is further configured to cooperate with the other AI-based engines of the cybersecurity appliance 150, via interfaces and/or direct integrations, to track and understand the cyber threat identified by the other components as well as track the one or more mitigation actions to be undertaken to mitigate the cyber threat during a cyber-attack by the other components in order to assist in intelligently restoring the protected system while still mitigating the cyber threat attack back to a trusted operational state. Thus, as a situation develops with an ongoing cyber-attack, the cyber-attack restoration engine 170 is configured to take one or more remediation actions to remediate (e.g., restore) at least one component within the AI-based cybersecurity system 100 back to a trusted operational state while the cyber-attack is still ongoing.

The cyber-attack restoration engine 170 is configured to identify device configuration exploited by current threat landscape techniques where adjustments to the device configuration may improve security of a computing device or network protected by the AI-based cybersecurity system 100. The cyber-attack restoration engine 170 is further configured to provide explanations in an NLP format the benefits and/or adjustments recommended to improve device/network security. Likewise, cyber-attack simulation engine 160 is configured to identify device components and operability exploited by current threat landscape techniques where adjustments to the device components and/or operability may improve security of a computing device or network to which the computing device is connected. The cyber-attack simulation engine 160 is further configured to provide explanations in an NLP format the benefits and/or adjustments recommended to improve device/network security.

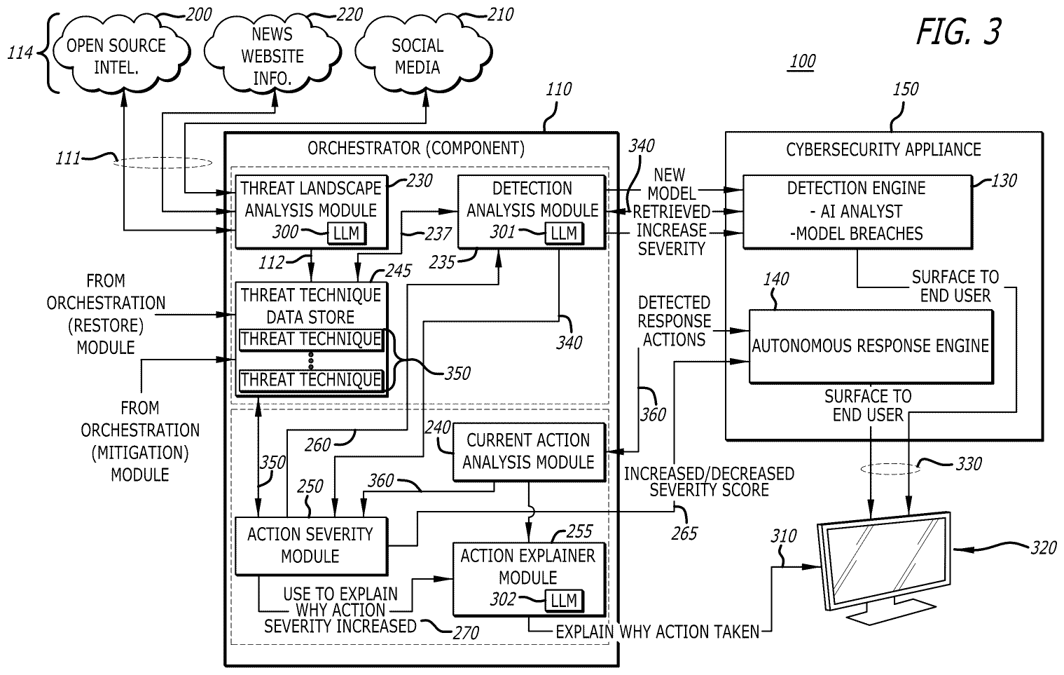

Referring now to FIG. 3, a detailed block diagram of an embodiment of the orchestration component 110 of FIG. 2 operating with the cybersecurity appliance 150 and configured to generate explanation message 310 for display on a computing device 320 with analytic results 330 produced by the cybersecurity appliance 150 is shown. Similar to FIG. 2, the orchestration component 110 is configured to receive the (unstructured) threat landscape information 111 from the external sources 114, which may include open source cyberthreat intelligence 200, social media information 210, and/or (iii) news website information 220. Also, the orchestration component 110 includes the threat landscape analysis module 230, the detection analysis module 235, the current action analysis module 240, a threat technique data store 245, the action severity module 250, and/or the action explainer module 255.

According to one embodiment of the disclosure, the threat landscape analysis module 230, the detection analysis module 235 and the action explainer module 255 are configured to operate with one or more LLMs such as a first LLM 300, a second LLM 301 and a third LLM 302. As shown, these modules 230, 235 and 255 may be configured as logic that utilizes LLMs 300-302, which is(are) implemented as part of the orchestration component 110. Alternatively, although not shown, the one or more LLMs may be located remotely from (and communicatively coupled to) the orchestration component 110 (e.g., the threat landscape analysis module 230, the detection analysis module 235, and the action explainer module 255).

More specifically, the threat landscape analysis module 230 may be configured to operate with the first LLM 300 to conduct LLM-based analytics on the threat landscape content 200/210/220 (e.g., rich text analytics) to produce the threat technique data 112. The threat technique data 112 identifies the techniques and tools associated with cyber threats identified within the threat landscape content 200/210/220.

The orchestration component 110 is further configured to utilize at least the third LLM 302, deployed as part of or accessible to the action explainer module 255, to generate the explanation messages 310. The explanation messages 310 may include content in an NLP format that states why certain response actions are being conducted and/or content in an NLP format to explain why the severity of the response actions has been increased, decreased, or remains constant. The content of the explanation messages 310 along with the content associated with the analytic results 330 is provided to the user computing device 320.

More specifically, the threat landscape analysis module 230 is configured to extract the threat technique data 112 from the threat landscape information 111 received from one or more sources 114, where the threat technique data 112 including data associated with techniques and/or tools utilized by current cyber threats detected externally from the AI-based cybersecurity system 100 and described as part of the threat landscape information 111. The threat landscape analysis module 230 is configured to conduct analytics on the threat landscape information 111 to identify and extract the threat technique data 112, which includes salient data pertaining to cyber threats associated with the current threat landscape (e.g., threat actor, targeted industries, targeted geographic regions, etc.) and/or data associated with one or more techniques deployed for the current cyber threat to breach a targeted destination such as an enterprise network or a computing device. Thereafter, the threat technique data 112 is stored within the threat technique data store 245 accessible by the detection analysis module 235 and/or the action severity module 250.

The action severity module 250 is communicatively coupled to the detection analysis module 235, the current action analysis module 240, the threat technique data store 245, and the action explainer module 255. For this embodiment, the action severity module 250 is configured to communicate with the detection analysis module 235 by at least retrieving information 340 associated with the cyber threats recently detected by the cyber threat detection engine 130. This retrieved information 340 may include identifiers of one or more AI models utilized by the cyber threat detection engine 130 to conduct analytics on incoming, monitored data to detect whether a cyber threat, such as cyber-attack (e.g., AI model breach) for example, has occurred. The retrieved information 340 may also include information associated with the events that pertain to cyber threats, which are detected by the cyber threat detection engine 130 or are being attempted in accordance with one of the threat techniques represented by the threat technique data 112 maintained within the threat technique data store 245. The threat technique data store 245 operates as a rolling window thereby storing the threat technique data 112 for a prescribed period of time (e.g., a few hours, a day, a few days, a week or even a few weeks) so that the threat landscape pertains to cyber threats that are currently targeting networks and/or computing devices.

The action severity module 250 is configured to generate the first severity score message 260, which may be used by the detection analysis module 235 to adjust the sensitivity of the cyber threat detection engine 130 (and AI models accessed by the cyber threat detection engine 130) by signaling the cyber threat detection engine 130 to increase or decrease its detection severity setting. The detection severity setting may include (i) increasing or decreasing correlation thresholds (e.g., threshold values set in the AI models utilized by the cyber threat detection engine 130) in determining whether monitored data associated with detected potential cyber threats is consistent with a cyber threat technique captured by the threat technique data 112 and/or (ii) setting the alert process in notifying an administrator that monitored data may constitute the cyber threat pertaining to one or more cyber threat techniques stored within the threat technique data store 245.

More specifically, after the retrieved information 340 associated with the cyber threats recently detected by the cyber threat detection engine 130 has been received from the detection analysis module 235, the action severity module 250 determines whether the retrieved information 340 is correlated with the stored threat technique data 350 (cyber threat activity) identified in the threat technique data 112. If so, the action severity module 250 generates the first severity score message 260 to enhance threat detection for cyber threat activity directed to the stored threat technique data 350.

According to one embodiment of the disclosure, to enhance cyber threat detection, the first severity score message 260 may include information that causes logic within the cyber threat detection engine 130 to increase the frequency or processing time allocated to search for that cyber threat activity and/or decreasing a correlation threshold representing the level of correlation needed between the monitored data to cyber threat activities associated with at least a portion of the stored threat technique data 350 to determine the presence of a potential cyber threat. As a result, the reduced correlation threshold may cause the cyber threat detection engine 130 to issue alerts more readily for cyber threats pertaining to the stored threat technique data 350 identified by the threat technique data 112.

According to one embodiment of the disclosure, additionally or in the alternative, the action severity module 250 may generate the first severity score message 260 with the increased severity score to adjust the severity (e.g., urgency) of alerts associated with detected cyber threats. For instance, the first severity score message 260 may include information to cause the cyber threat detection engine 130 to adjust the visual representation of the detected cyber threats on a dashboard (see FIG. 6). As an illustrative example, the first severity score message 260 may include information that causes logic within the cybersecurity appliance 150 (e.g., the cyber threat detection engine 130, AI models, etc.) to prioritize ordering of displayable alerts differently, with alerts associated with cyber threats identified in the threat technique data 112 given higher priority. As another illustrative example, the first severity score message 260 may include information that causes logic within the cybersecurity appliance 150 to adjust display location of these threat landscape-based alerts, changing a visual rendering of these alert through changes in font, (e.g., size, color, type, etc.), activating one or more additional alert delivery schemes (e.g., text alert, audio notification, etc.) to notify the administrator of these threat landscape-based alerts, or the like.

Similarly, where a current cyber threat represented by particular threat technique data 350 is becoming less pervasive, the action severity module 250 may generate the first severity score message 260 adapted to cause logic within the cyber threat detection engine 130 to reduce threat detection for cyber threat activity directed to the stored threat technique data 350 identified by the threat technique data 112. This may be accomplished by reducing the frequency or processing time allocated to search for that cyber threat activity, increasing the above-identified correlation threshold, reducing the frequency of alerts, and/or altering positioning such alerts (e.g., lower ranked order, less prominent, etc.). As a result, when the increased correlation threshold is set, the cyber threat detection engine 130 may require more definitive evidence of a potential cyber threat before issuing an alert.

As further shown in FIG. 3, the action severity module 250 may be configured to communicate with the current action analysis module 240 and retrieve information associated with detected response actions 360 being conducted by the autonomous response engine 140. As shown, the current action analysis module 240 is communicatively coupled to the autonomous response engine 140 and is adapted to obtain the response actions 360. In response to determining that the monitored cyber threat activity received from the detection analysis module 235 is correlated with cyber threat activity identified in the threat technique data 112, the action severity module 250 may be configured to generate the second severity score message 265, which is adapted to cause logic within the cybersecurity appliance 150 (e.g., autonomous response engine 140, AI model(s) utilized by the engine 140, etc.) to increase the severity of the response actions conducted by the autonomous response engine 140 to combat the cyber threat or decrease the severity of the response actions based on the frequency of detected cyber threats identified by the threat technique data 112 significantly lessening. The response actions may be performed autonomously without human intervention or the recommended response action(s) may displayed in association with the detected cyber threat.

The increase/decrease in severity of the response actions may be accomplished by the action severity module 250 sending the second severity score message 265 to the autonomous response engine 140. The second severity score message 265 includes a value (severity score) that causes the autonomous response engine 140 and/or AI models utilized by the autonomous response engine 140 to alter its action severity setting to now utilize a second set of response actions in lieu of a first set of response actions. Namely, a change in the action severity setting of the autonomous response engine 140 may correspond to (i) a change in a set of response actions conducted by the autonomous response engine 140 upon detecting events consistent with a cyber threat technique captured by the threat technique data 112 and/or (ii) a change in the alert process associated with a notification scheme for identifying one or more detected response actions.

For instance, an increased severity score may be included as part of the second severity score message 265 based on analysis of the response actions currently being performed by the autonomous response engine 140 in light of the types of cyber threats identified by the threat technique data 112. The severity score may be increased to prompt the autonomous response engine 140 to perform the second set of response actions, different than the first set of response actions being performed, where the second set of response actions are considered to be more aggressive approach in handling the detected cyber threat.

As an illustrative example, the first set of response actions may identify a log event or a quarantine event. The increased severity score may be selected by the action severity module 250 to alter operability of the autonomous response engine 140 in responding to all types or even particular types of cyber threats (e.g., cyber threats involving the stored threat technique data 350 obtained from the threat technique data 112) through a second set of response actions (e.g., blocking communications, revoke permissions, or even shut down a targeted computing device). According to one embodiment of the disclosure, the second set of response actions, selected based on the severity score, may constitute a partial or complete substitution of the response actions within the first set of response actions. These different and newly added response actions are adapted to provide heightened security to computing device(s) and the network protected by the AI-based cybersecurity system 100.

Similarly, for a decreased severity score included as part of the second severity score message 265 may prompt the autonomous response engine 140 to return to the first set of response actions or eliminate one of more response actions. For example, the decreased severity score may eliminate any actions in halting communications, where potential cyber threats are merely log data associated with the potential cyber threats for future evaluation (e.g., log data, no quarantine activity as set forth in the first set of response actions).

According to one embodiment of the disclosure, additionally or in the alternative, the action severity module 250 may generate the second severity score message 265 with the increased severity score to adjust the severity of alert actions by the autonomous response engine 140. For instance, the second severity score message 265 may include information to cause the autonomous response engine 140 to adjust its alert notification scheme, which may include adjusting the visual representation of the alert on a dashboard (see FIG. 6). As an illustrative example, the second severity score message 265 may include information that causes the autonomous response engine 140 to prioritize ordering of displayable alerts differently, with alerts associated with cyber threats identified in the threat technique data 112 given higher priority. As another illustrative example, the second severity score message 265 may include information that causes the autonomous response engine 140 to adjust display location of these threat landscape-based alerts, changing a visual rendering of these alert through changes in font, (e.g., size, color, type, etc.), activating one or more additional alert delivery schemes (e.g., text alert, audio notification, etc.) to notify the administrator of these threat landscape-based alerts, or the like. Similarly, a decreased severity score may adjust the severity of alert actions by reducing the frequency of alerts and/or positioning such alerts lower in ordering, less prominently, or the like.

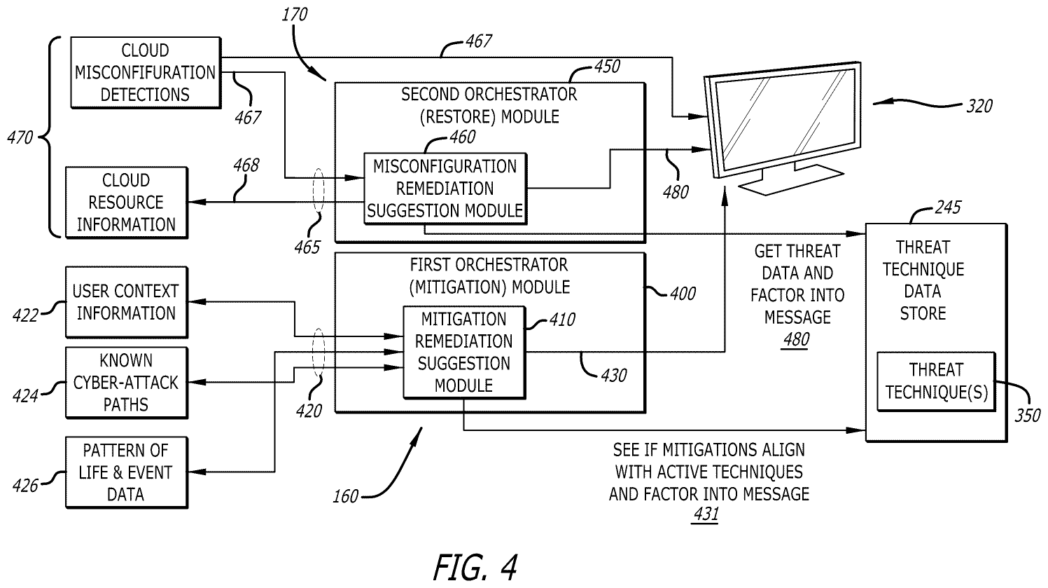

Referring now to FIG. 4, an illustrative embodiment of orchestrator modules 400 and 450 associated with the cyber-attack simulation engine 160 and the cyber-attack restoration engine 170 is shown. The orchestrator modules 400 and 450 are communicatively coupled to the orchestration component 110 of FIG. 2 to acquire portions of the threat technique data 112 stored within the threat technique data store 245 to assist in generation of recommendation messages 430 and 480. The recommendation messages 430 and 480 are directed to preventative security.

Herein, the cyber-attack simulation engine 160 includes a first orchestrator (mitigation) module 400 deployed as an LLM, using AI algorithms coded and trained to perform AI-based simulations of cyber-attacks, to assist in determining 1) how a simulated cyber-attack might occur in a selected computing device protected by the AI-based cybersecurity system 100, and 2) how to use the simulated cyber-attack information to preempt possible escalations of an ongoing actual cyber-attack. Stated differently, the first orchestrator module 400 may be triggered during a training session or another prescribed period of time, either synchronous or asynchronous, to establish a communication session (e.g., series of API calls and returned responses) with the selected computing device to acquire information associated with its operability and the operability of certain components that, if adjusted, may improve device and network security.

As an illustrative example, as shown in FIG. 4, the first orchestrator module 400 features a mitigation remediation suggestion module 410 configured to initiate a series of API calls to multiple computing devices to acquire information 420 associated with these devices where the acquired information may be directed to their external exposure. Examples of the acquired information 420 gathered from iterative API calls to each computing device under analysis may include, but is not limited or restricted to the following: (1) user context information 422 (e.g., user permissions, location of user, etc.); (2) known cyber-attack paths 424 to discern any prior access to these paths; and/or (3) pattern of life event data 426 that provides an intrinsic understanding of normal behavior for the selected computing device, its network connectivity, and registered user of the computing device. The pattern of life event data 426 may include (i) traffic pattern (e.g., patterns in communication, such as frequent connections to specific domains or services as well as unusual or unexpected patterns that may indicate suspicious activity), (ii) log data (e.g., firewall log data that maintains a record of incoming and outgoing network traffic including blocked connections and communication attempts, access logs that maintain successful logins and unauthorized access attempts from unexpected locations could indicate external communication), (iii) DNS requests, (iv) system processes and ports (e.g., active processes and open ports), and/or (v) application-level insights such as web browsers (e.g., type, version, update history, etc.), email clients (e.g., source domains for emails, destination domains for emails, etc.), filesharing tools (e.g., file upload and download history, file type, file size, etc.), instant messaging applications (e.g., chat log data, etc.), and/or cloud services (e.g., synchronization logs for interaction with cloud storage services, etc.).

Based on the acquired information 420, the mitigation remediation suggestion module 410 assigns an external exposure score to each analyzed computing device to prioritize the computing devices with a greatest external exposure. Thereafter, the mitigation remediation suggestion module 410 conducts analytics on a prescribed number of computing devices within an external exposure score range (e.g., highest score, top-3, top-5, top-50, bottom, etc.) to focus further analytics as what adjustments to their functionality (e.g., settings, password, software updates, software removals, etc.) may be performed to reduce a likelihood of a successful cyber-attack on these computing devices. The mitigation remediation suggestion module 410 may access the threat technique data store 245 of FIG. 3 to determine if any mitigation suggestions align with the stored threat technique data 350 and factor into a mitigation recommendation to be suggested by the mitigation remediation suggestion module 410.

Thereafter, the mitigation remediation suggestion module 410 generates the first recommendation message 430, which includes the mitigation recommendations for a first computing device along with a listing of steps (e.g., in text format, URL links, etc.) to perform operations to increase security of the computing device.

The cyber-attack restoration engine 170 is configured to use AI algorithms configured and trained to perform a third machine-learned task of remediating the AI-based cybersecurity system 100 being protected back to a trusted operational state.

Referring still to FIG. 4, the cyber-attack restoration engine 170 includes a second orchestrator (restore) module 450 deployed as an LLM, using AI algorithms coded and trained to perform a third machine-learned task of remediating the AI-based cybersecurity system 100 to correct misconfigurations in certain components 470 associated with the AI-based cybersecurity system 100 and/or return these components back to a trusted operational state. Stated differently, the second orchestrator module 450 may be triggered during a training session or another prescribed period of time, either synchronous or asynchronous, to establish a communication session (e.g., series of API calls and returned responses) with the components such as cloud-based components.

The second orchestrator (restore) module 450 features a misconfiguration remediation suggestion module 460 configured to establish communications with and acquire information 465 from the components 470. The acquired information 465 may include detected misconfigurations 467 of the components 470 provided from a cloud service provider along with cloud resource information 468 to more context associated with the components 470. Additionally, the misconfiguration remediation suggestion module 460 is configured to establish communications with the orchestration component 110 of FIGS. 1-3, namely the threat technique data store 245 of FIG. 2, to obtain data pertaining to the cyber threats to the cloud services to factor this information into the second recommendation message 480 to be suggested by the misconfiguration remediation suggestion module 460.

Thereafter, the misconfiguration remediation suggestion module 460 generates the second recommendation message 480, which includes the misconfiguration and/or restore recommendations for a cloud components along with a listing of steps (e.g., in text format, URL links, etc.) to perform the recommended operations to increase network security. The misconfiguration remediation suggestion module 460 is further configured to provide the recommendation in an NLP format, outlining how to effectuate the misconfiguration or restore operation and the benefits and/or adjustments recommended to improve device/network security. The content associated with the detected (cloud) misconfigurations 467 also may be provided directly to the computing device 320 for display with the misconfiguration and/or store recommendations from the second recommendation message 480.

### VIII. Cybersecurity Appliance Architecture

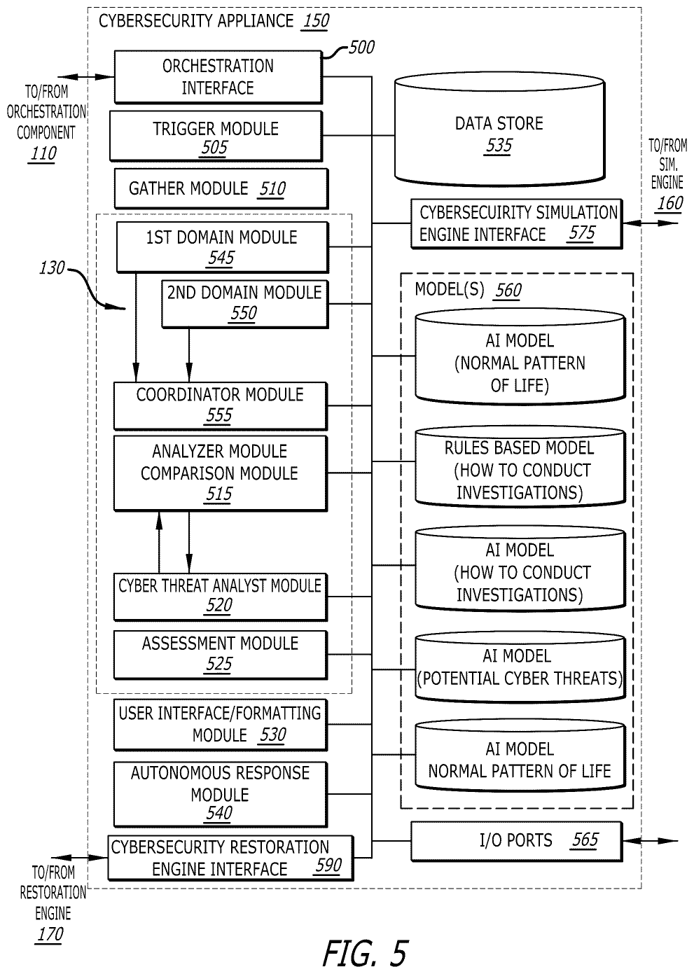

Referring now to FIG. 5, a block diagram of an embodiment of the cybersecurity appliance 150 that protects the AI-based cybersecurity system 100 is shown, including but not limited to a network/domain, from cyber threats. Various AI models and modules of the cybersecurity appliance 150 cooperate to protect one or more networks/domains under analysis from cyber threats. As shown, according to one embodiment of the disclosure, the cybersecurity appliance 150 is communicatively coupled to the orchestration component 110 via orchestration interface 500, where the orchestration component 110 is configured to adjust operability (detections and response actions), provide explanation for the changes in operability, simulate cyber-attacks and provide recommendations to circumvent an actual future attack based on communications with the cybersecurity simulation engine 160 via interface 575 and the cybersecurity restoration engine via interface 590, and restore safe network/device operability (correct misconfiguration, restore) and provide recommendation to perform such restoration, as described in FIGS. 1-4. Certain operations and components of the AI-based cybersecurity appliance 150 are described below.

The cybersecurity appliance 150 may include a trigger module 505, a gather module 510, the cyber threat detection engine 130, a cyber threat analyst module 520, an assessment module 525, a formatting module 530, a data store 535 that may include the threat technique data store 245 of FIG. 2, the autonomous response engine 140, a first (1^{st}) domain module 545, a second (2^{nd}) domain module 550, and a coordinator module 555, one or more AI models 560 (hereinafter, AI model(s)”), and/or other modules. The AI model(s) 560 may be trained with machine learning on a normal pattern of life for entities in the network(s)/domain(s) under analysis, with machine learning on cyber threat hypotheses to form and investigate a cyber threat hypothesis on what are a possible set of cyber threats and their characteristics, symptoms, remediations, etc., and/or trained on possible cyber threats including their characteristics and symptoms, a data store, an autonomous response module, a 5st domain module, a 2nd domain module, and a coordinator module.

The cybersecurity appliance 150 with the Artificial Intelligence (AI) based cybersecurity system may protect a network/domain from a cyber threat. In an embodiment, the cybersecurity appliance 150 can protect all of the devices (e.g., computing devices on the network(s)/domain(s) being monitored by monitoring domain activity including communications). For example, a network domain module (e.g., first domain module 545) may communicate with network sensors to monitor network traffic going to and from the computing devices on the network as well as receive secure communications from software agents embedded in host computing devices/containers. The steps below will detail the activities and functions of several of the components in the cybersecurity appliance 150. Also, an orchestration component interface 500 provides the modules deployed within the orchestration component 110 with access to engines/modules within the cybersecurity appliance 150 and/or engines/modules accessible by the cybersecurity appliance 150. I/O ports 565 provide I/O access for data processing by the cybersecurity appliance 150.

The gather module 510 may be configured with one or more process identifier classifiers. Each process identifier classifier may be configured to identify and track one or more processes and/or devices in the network, under analysis, making communication connections. The data store 535 cooperates with the process identifier classifier to collect and maintain historical data of processes and their connections, which is updated over time as the network is in operation. Individual processes may be present in merely one or more domains being monitored. In an example, the process identifier classifier can identify each process running on a given device along with its endpoint connections, which are stored in the data store 535. In addition, a feature classifier can examine and determine features in the data being analyzed into different categories.

The cyber threat detection engine 130 can cooperate with the AI model(s) 560 or other modules in the cybersecurity appliance 150 to confirm a presence of a cyber-attack against an enterprise such as one or more domains utilized by the enterprise. A process identifier in the cyber threat detection engine 130 can cooperate with the gather module 510 to collect any additional data and metrics to support a possible cyber threat hypothesis. Similarly, the cyber threat analyst module 520 can cooperate with the internal data sources as well as external data sources to collect data in its investigation. More specifically, the cyber threat analyst module 520 can cooperate with the other modules and the AI model(s) 560 in the cybersecurity appliance 150 to conduct a long-term investigation and/or a more in-depth investigation of potential and emerging cyber threats directed to one or more domains in an enterprise's system. Herein, the cyber threat analyst module 520 and/or the cyber threat detection engine 130 can also monitor for other anomalies, such as model breaches, including, for example, deviations for a normal behavior of an entity, and other techniques discussed herein. As an illustrative example, the cyber threat detection engine 130 and/or the cyber threat analyst module 520 can cooperate with the AI model(s) 560 trained on potential cyber threats in order to assist in examining and factoring these additional data points that have occurred over a given timeframe to see if a correlation exists between 5) a series of two or more anomalies occurring within that time frame and 2) possible known and unknown cyber threats. The cyber threat analyst module can cooperate with the internal data sources as well as external data sources to collect data in its investigation.

According to one embodiment of the disclosure, the cyber threat analyst module 520 allows two levels of investigations of a cyber threat that may suggest a potential impending cyber-attack. In a first level of investigation, the cyber threat detection engine 130 and AI model(s) 560 can rapidly detect and then the autonomous response engine 140 will autonomously respond to overt and obvious cyber-attacks. However, thousands to millions of low level anomalies occur in a domain under analysis all of the time; and thus, most other systems need to set the threshold of trying to detect a cyber-attack by a cyber threat at level higher than the low level anomalies examined by the cyber threat analyst module 520 just to not have too many false positive indications of a cyber-attack when one is not actually occurring, as well as to not overwhelm a human cybersecurity analyst receiving the alerts with so many notifications of low level anomalies that they just start tuning out those alerts. However, advanced persistent threats attempt to avoid detection by making these low-level anomalies in the system over time during their cyber-attack before making their final coup de grace/ultimate mortal blow against the system (e.g., domain) being protected. The cyber threat analyst module 520 also conducts a second level of investigation over time with the assistance of the AI model(s) 560 trained with machine learning on how to form cyber threat hypotheses and how to conduct investigations for a cyber threat hypothesis that can detect these advanced persistent cyber threats actively trying to avoid detection by looking at one or more of these low-level anomalies as a part of a chain of linked information.

Note, a data analysis process can be algorithms/scripts written by humans to perform their function discussed herein; and can in various cases use AI classifiers as part of their operation. The cyber threat analyst module 520 forms in conjunction with the AI model(s) 560 trained with machine learning on how to form cyber threat hypotheses and how to conduct investigations for a cyber threat hypothesis investigate hypotheses on what are a possible set of cyber threats. The cyber threat analyst module 520 can also cooperate with the cyber threat detection engine 130 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 560 trained with machine learning on the normal pattern of life of entities in the system. The cyber threat analyst module 520 may submit to check and recheck various combinations/a chain of potentially related information, including abnormal behavior of a device/user account under analysis for example, until each of the one or more hypotheses on potential cyber threats are one of 5) refuted, 2) supported, or 5) included in a report that includes details of activities assessed to be relevant activities to the anomaly of interest to the user and that also conveys at least this particular hypothesis was neither supported or refuted. For this embodiment, a human cybersecurity analyst is needed to further investigate the anomaly (and/or anomalies) of interest included in the chain of potentially related information.

Returning still to FIG. 5, an input from the cyber threat analyst module 520 of a supported hypothesis of a potential cyber threat will trigger the cyber threat detection engine 130 to compare, confirm, and send a signal to act upon and mitigate that cyber threat. In contrast, the cyber threat analyst module 520 investigates subtle indicators and/or initially seemingly isolated unusual or suspicious activity such as a worker is logging in after their normal working hours or a simple system misconfiguration has occurred. Most of the investigations conducted by the cyber threat analyst module 520 cooperating with the AI model(s) 560 trained with machine learning on how to form cyber threat hypotheses and how to conduct investigations for a cyber threat hypothesis on unusual or suspicious activities/behavior may not result in a cyber threat hypothesis that is supported but rather most are refuted or simply not supported. Typically, during the investigations, several rounds of data gathering to support or refute the long list of potential cyber threat hypotheses formed by the cyber threat analyst module 520 will occur before the algorithms in the cyber threat analyst module 520 will determine whether a particular cyber threat hypothesis is supported, refuted, or needs further investigation by a human. The rounds of data gathering may build chains of linked low-level indicators of unusual activity along with potential activities that could be within a normal pattern of life for that entity to evaluate the whole chain of activities to support or refute each potential cyber threat hypothesis formed. The investigations by the cyber threat analyst module 520 can happen over a relatively long period of time and be far more in depth than the cyber threat detection engine 130 which will work with the other modules and AI model(s) 560 to confirm that a cyber threat has in fact been detected.

The gather module 510 may further extract data from the data store 535 at the request of the cyber threat analyst module 520 and/or cyber threat detection engine 130 on each possible hypothetical threat that would include the abnormal behavior or suspicious activity and then can assist to filter that collection of data down to relevant points of data to either 5) support or 2) refute each particular hypothesis of what the cyber threat, the suspicious activity and/or abnormal behavior relates to. The gather module 510 cooperates with the cyber threat analyst module 520 and/or cyber threat detection engine 130 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

Thus, the cyber threat analyst module 520 is configured to cooperate with the AI model(s) 560 trained with machine learning on how to form cyber threat hypotheses and how to conduct investigations for a cyber threat hypothesis to form and investigate hypotheses on what are a possible set of cyber threats and then can cooperate with the cyber threat detection engine 130 with the one or more data analysis processes to confirm the results of the investigation on the possible set of cyber threats hypotheses that would include the at least one of i) the abnormal behavior, ii) the suspicious activity, and iii) any combination of both, identified through cooperation with the AI model(s) 560 trained with machine learning on the normal pattern of life/normal behavior of entities in the domains under analysis.

Note, in the first level of threat detection, the gather module 510 and the cyber threat detection engine 130 cooperate to supply any data and/or metrics requested by the cyber threat detection engine 130 cooperating with the AI model(s) 560 trained on possible cyber threats to support or rebut each possible type of cyber threat. Again, the cyber threat detection engine 130 can cooperate with the AI model(s) 560 and/or other modules to rapidly detect and then cooperate with the autonomous response engine 140 to autonomously respond to overt and obvious cyber-attacks, (including ones found to be supported by the cyber threat analyst module 520).

As a starting point, the cybersecurity appliance 150 can use multiple modules, each capable of identifying abnormal behavior and/or suspicious activity against the AI model(s) 560 trained on a normal pattern of life for the entities in the network/domain under analysis, which is supplied to the cyber threat detection engine 130 and/or the cyber threat analyst module 520. The cyber threat detection engine 130 and/or the cyber threat analyst module 520 may also receive other inputs such as AI model breaches, AI classifier breaches, etc. a trigger to start an investigation from an external source.

Many other model breaches of the AI model(s) 560 trained with machine learning on the normal behavior of the system can send an input into the cyber threat analyst module 520 and/or the trigger module 505 to trigger an investigation to start the formation of one or more hypotheses on what are a possible set of cyber threats that could include the initially identified abnormal behavior and/or suspicious activity. Note, a deeper analysis can look at example factors such as i) how long has the endpoint existed or is registered; ii) what kind of certificate is the communication using; iii) is the endpoint on a known good domain or known bad domain or an unknown domain, and if unknown what other information exists such as registrant's name and/or country; iv) how rare; v), etc.

Note, the cyber threat analyst module 520 cooperating with the AI model(s) 560 trained with machine learning on how to form cyber threat hypotheses and how to conduct investigations for a cyber threat hypothesis in the cybersecurity appliance 150 provides an advantage as it reduces the time taken for human led or cybersecurity investigations, provides an alternative to manpower for small organizations and improves detection (and remediation) capabilities within the cybersecurity appliance 150.

The cyber threat analyst module 520, which forms and investigates hypotheses on what are the possible set of cyber threats, can use hypotheses mechanisms including any of 5) one or more of the AI model(s) 560 trained on how human cybersecurity analysts form cyber threat hypotheses and how to conduct investigations for a cyber threat hypothesis that would include at least an anomaly of interest, 2) one or more scripts outlining how to conduct an investigation on a possible set of cyber threats hypotheses that would include at least the anomaly of interest, 5) one or more rules-based models on how to conduct an investigation on a possible set of cyber threats hypotheses and how to form a possible set of cyber threats hypotheses that would include at least the anomaly of interest, and 4) any combination of these. Again, the AI model(s) 560 trained on ‘how to form cyber threat hypotheses and how to conduct investigations for a cyber threat hypothesis’ may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 520 and/or the cyber threat detection engine 130 can feed the cyber threat details to the assessment module 525 to generate a threat risk score that indicate a level of severity of the cyber threat.

According to one embodiment of the disclosure, the assessment module 525 can cooperate with the AI model(s) 560 trained on possible cyber threats to use AI algorithms to identify actual cyber threats and generate threat risk scores based on both the level of confidence that the cyber threat is a viable threat and the severity of the cyber threat (e.g., attack type where ransomware attacks has greater severity than phishing attack; degree of infection; computing devices likely to be targeted, etc.). The threat risk scores be used to rank alerts that may be directed to enterprise or computing device administrators. This risk assessment and ranking is conducted to avoid frequent “false positive” alerts that diminish the degree of reliance/confidence on the cybersecurity appliance 150.

Training of AI Pre Deployment and then During Deployment

In step 5, an initial training of the AI model trained on cyber threats can occur using unsupervised learning and/or supervised learning on characteristics and attributes of known potential cyber threats including malware, insider threats, and other kinds of cyber threats that can occur within that domain. Each Artificial Intelligence can be programmed and configured with the background information to understand and manage particulars, including different types of data, protocols used, types of devices, user accounts, etc. of the system being protected. The Artificial Intelligence pre-deployment can all be trained on the specific machine learning task that they will perform when put into deployment. For example, the AI model, such as AI model(s) 560 or example (hereinafter “AI model(s) 560”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats.

In this example, one of the AI model(s) 560 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cybersecurity appliance 150, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyber-attacks.

In an embodiment, the AI model(s) 560 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

A deployed AI model trained on a normal pattern of life of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of the AI model(s) 560 of FIG. 5 trained with machine learning on the pattern of life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of the AI model(s) 560 of FIG. 5 trained on a normal pattern of life of entities in the system can occur. Initial training of the AI model(s) 560 trained with machine learning on a behavior of the pattern of life of the entities in the network/domain can occur where each type of network and/or domain will generally have some common typical behavior with each model trained specifically to understand components/devices, protocols, activity level, etc. to that type of network/system/domain. What is normal behavior of each entity within that system can be established either prior to deployment and then adjusted during deployment or alternatively the model can simply be placed into an observation mode for an initial week or two when first deployed on a network/domain in order to establish an initial normal behavior for entities in the network/domain under analysis.

During deployment, what is considered normal behavior will change as each different entity's behavior changes and will be reflected through the use of unsupervised learning in the model such as various Bayesian techniques, clustering, etc. The AI model(s) 560 can be implemented with various mechanisms such neural networks, decision trees, etc. and combinations of these. Likewise, one or more supervised machine learning AI model(s) 560 may be trained to create possible hypotheses and perform cyber threat investigations on agnostic examples of past historical incidents of detecting a multitude of possible types of cyber threat hypotheses previously analyzed by human cybersecurity analyst. AI model(s) 560 are trained to create one or more possible hypotheses and perform cyber threat investigations will be discussed later.

At its core, the self-learning AI model(s) 560 that model the normal behavior (e.g. a normal pattern of life) of entities in the network mathematically characterizes what constitutes ‘normal’ behavior, based on the analysis of a large number of different measures of a device's network behavior—packet traffic and network activity/processes including server access, data volumes, timings of events, credential use, connection type, volume, and directionality of, for example, uploads/downloads into the network, file type, packet intention, admin activity, resource and information requests, command sent, etc.

### Clustering Methods

In order to model what should be considered as normal for a device or cloud container, its behavior can be analyzed in the context of other similar entities on the network. The AI models (e.g., AI model(s) 560) can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cybersecurity analyst. AI models trained on forming and investigating hypotheses on what are a possible set of cyber threats can be trained initially with supervised learning. Thus, these AI models can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful.

Next, the various AI models and AI classifiers combine use of unsupervised and supervised machine learning to learn ‘on the job’—it does not depend upon solely knowledge of previous cyber-attacks. The AI models and classifiers combine use of unsupervised and supervised machine learning constantly revises assumptions about behavior, using probabilistic mathematics, which is always up to date on what a current normal behavior is, and not solely reliant on human input. The AI models and classifiers combine use of unsupervised and supervised machine learning on cybersecurity is capable of seeing hitherto undiscovered cyber events, from a variety of threat sources, which would otherwise have gone unnoticed.

Next, these cyber threats can include, for example, Insider threat—malicious or accidental, Zero-day attacks—previously unseen, novel exploits, latent vulnerabilities, machine-speed attacks—ransomware and other automated attacks that propagate and/or mutate very quickly, Cloud and SaaS-based attacks, other silent and stealthy attacks advance persistent threats, advanced spear-phishing, etc.

### Ranking the Cyber Threat

The assessment module 525 and/or cyber threat analyst module 520 of FIG. 5 can cooperate with the AI model(s) 560 trained on possible cyber threats to use AI algorithms to account for ambiguities by distinguishing between the subtly differing levels of evidence that characterize network data. Instead of generating the simple binary outputs ‘malicious’ or ‘benign,’ the AI's mathematical algorithms produce outputs marked with differing degrees of potential threat. This enables users of the system to rank alerts or notifications to the enterprise security administrator in a rigorous manner and prioritize those which most urgently require action. Meanwhile, it also assists to avoid the problem of numerous false positives associated with simply a rule-based approach.

As discussed in more detail above, the cyber threat detection engine 130 and/or cyber threat analyst module 520 can cooperate with the one or more unsupervised AI (machine learning) model 560 trained on the normal pattern of life/normal behavior in order to perform anomaly detection against the actual normal pattern of life for that system to determine whether an anomaly (e.g., the identified abnormal behavior and/or suspicious activity) is malicious or benign. In the operation of the cybersecurity appliance 150, the emerging cyber threat can be previously unknown, but the emerging threat landscape information 570 representative of the emerging cyber threat shares enough (or does not share enough) in common with the traits from the AI model(s) 560 trained on cyber threats to now be identified as malicious or benign. Note, if later confirmed as malicious, then the AI model(s) 560 trained with machine learning on possible cyber threats can update their training. Likewise, as the cybersecurity appliance 150 continues to operate, then the one or more AI models trained on a normal pattern of life for each of the entities in the system can be updated and trained with unsupervised machine learning algorithms. The cyber threat detection engine 130 can use any number of data analysis processes (discussed more in detail below and including the agent analyzer data analysis process here) to help obtain system data points so that this data can be fed and compared to the one or more AI models trained on a normal pattern of life, as well as the one or more machine learning models trained on potential cyber threats, as well as create and store data points with the connection finger prints.

The AI model(s) 560 of FIG. 5 can continually learn and train with unsupervised machine learning algorithms on an ongoing basis when deployed in their system that the cybersecurity appliance 150 is protecting. Thus, learning and training on what is normal behavior for each user, each device, and the system overall and lowering a threshold of what is an anomaly.

### Anomaly Detection/Deviations

Anomaly detection can discover unusual data points in your dataset. Anomaly can be a synonym for the word ‘outlier.’ Anomaly detection (or outlier detection) is the identification of rare items, events or observations which raise suspicions by differing significantly from the majority of the data. Anomalous activities can be linked to some kind of problems or rare events. Since there are tons of ways to induce a particular cyber-attack, it is difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous. The AI unsupervised learning model learns patterns from the features in the day-to-day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two-level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold (a parameter that can be tuned over time through the self-learning), where feature values with probability larger than this threshold indicate that the given feature's values are non-anomalous, otherwise it is anomalous. Note, this anomaly detection can determine that a data point is anomalous/non-anomalous on the basis of a particular feature. In reality, the cybersecurity appliance 150 should not flag a data point as an anomaly based on a single feature. Merely, when a combination of all the probability values for all features for a given data point is calculated can the modules cooperating with the AI model of normal behavior can say with high confidence whether a data point is an anomaly or not.

Again, the AI models trained on a normal pattern of life of entities in a system (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. Please reference U.S. Pat. No. 50,701,093 granted Jun. 50, 2020, titled “Anomaly alert system for cyber threat detection” for an example Bayesian probabilistic approach, which is incorporated by reference in its entirety. In addition, please reference US patent publication number “US2021273958A1 filed Feb. 26, 2021, titled “Multi-stage anomaly detection for process chains in multi-host environments” for another example anomalous behavior detector using a recurrent neural network and a bidirectional long short-term memory (LSTM), which is incorporated by reference in its entirety. In addition, please reference US patent publication number “US2020244673A1, filed Apr. 23, 2019, titled “Multivariate network structure anomaly detector,” which is incorporated by reference in its entirety, for another example anomalous behavior detector with a Multivariate Network and Artificial Intelligence classifiers.

Next, as discussed further below, during pre-deployment the cyber threat analyst module 520 and the cyber threat detection engine 130 can use data analysis processes and cooperate with AI model(s) 560 trained on forming and investigating hypotheses on what are a possible set of cyber threats. In addition, another set of AI models can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful.

Similarly, during deployment, the data analysis processes (discussed herein) used by the cyber threat detection engine 130 can use unsupervised machine learning to update the initial training learned during pre-deployment, and then update the training with unsupervised learning algorithms during the cybersecurity appliance's 150 deployment in the system being protected when various different steps to either i) support or ii) refute the possible set of cyber threats hypotheses worked better or worked worse.

The AI model(s) 560 trained on a normal pattern of life of entities in a domain under analysis may perform the threat detection through a probabilistic change in a normal behavior through the application of, for example, an unsupervised Bayesian mathematical model to detect a behavioral change in computers and computer networks. The Bayesian probabilistic approach can determine periodicity in multiple time series data and identify changes across single and multiple time series data for the purpose of anomalous behavior detection. In an example, a system being protected can include both email and IT network domains under analysis. Thus, email and IT network raw sources of data can be examined along with a large number of derived metrics that each produce time series data for the given metric.

### Additional Module Interactions

Referring back to FIG. 5, the gather module 510 cooperates with the data store 535. The data store 535 stores comprehensive logs for network traffic observed. These logs can be filtered with complex logical queries and each IP packet can be interrogated on a vast number of metrics in the network information stored in the data store. Similarly, other domain's communications and data, such as emails, logs, etc. may be collected and stored in the data store 535. The gather module 510 may consist of multiple automatic data gatherers that each look at different aspects of the data depending on the particular hypothesis formed for the analysed event. The data relevant to each type of possible hypothesis can be automatically pulled from additional external and internal sources. Some data is pulled or retrieved by the gather module 510 for each possible hypothesis.

The data store 535 can store the metrics and previous threat alerts associated with network traffic for a period of time, which is, by default, at least 27 days. This corpus of data is fully searchable. The cybersecurity appliance 150 works with network probes to monitor network traffic and store and record the data and metadata associated with the network traffic in the data store.

The gather module 510 may have a process identifier classifier. The process identifier classifier can identify and track each process and device in the network, under analysis, making communication connections. The data store 535 cooperates with the process identifier classifier to collect and maintain historical data of processes and their connections, which is updated over time as the network is in operation. In an example, the process identifier classifier can identify each process running on a given device along with its endpoint connections, which are stored in the data store. Similarly, data from any of the domains under analysis may be collected and compared.

Examples of domains/networks under analysis being protected can include any of i) an Informational Technology network, ii) an Operational Technology network, iii) a Cloud service, iv) a SaaS service, v) an endpoint device, vi) an email domain, and vii) any combinations of these. A domain module is constructed and coded to interact with and understand a specific domain.

For instance, the first domain module 545 may operate as an IT network module configured to receive information from and send information to, in this example, IT network-based sensors (i.e., probes, taps, etc.). The first domain module 545 also has algorithms and components configured to understand, in this example, IT network parameters, IT network protocols, IT network activity, and other IT network characteristics of the network under analysis. The second domain module 550 is, in this example, an email module. The second domain module 550 can be an email network module configured to receive information from and send information to, in this example, email-based sensors (i.e., probes, taps, etc.). The second domain module 550 also has algorithms and components configured to understand, in this example, email parameters, email protocols and formats, email activity, and other email characteristics of the network under analysis. Additional domain modules can also collect domain data from another respective domain.

The coordinator module 555 is configured to work with various machine learning algorithms and relational mechanisms to i) assess, ii) annotate, and/or iii) position in a vector diagram, a directed graph, a relational database, etc., activity including events occurring, for example, in the first domain compared to activity including events occurring in the second domain. The domain modules can cooperate to exchange and store their information with the data store.

The process identifier classifier (not shown) in the gather module 510 can cooperate with additional classifiers in each of the domain modules 545/150 to assist in tracking individual processes and associating them with entities in a domain under analysis as well as individual processes and how they relate to each other. The process identifier classifier can cooperate with other trained AI classifiers in the modules to supply useful metadata along with helping to make logical nexuses.

A feedback loop of cooperation exists between the gather module 510, the cyber threat detection engine 130, AI model(s) 560 trained on different aspects of this process, and the cyber threat analyst module 520 to gather information to determine whether a cyber threat is potentially attacking the networks/domains under analysis.

### Determination of Whether Something is Likely Malicious

In the following examples the cyber threat detection engine 130 and/or cyber threat analyst module 520 can use multiple factors to the determination of whether a process, event, object, entity, etc. is likely malicious.

In an example, the cyber threat detection engine 130 and/or cyber threat analyst module 520 can cooperate with one or more of the AI model(s) 560 trained on certain cyber threats to detect whether the anomalous activity detected, such as suspicious email messages, exhibit traits that may suggest a malicious intent, such as phishing links, scam language, sent from suspicious domains, etc. The cyber threat detection engine 130 and/or cyber threat analyst module 520 can also cooperate with one of more of the AI model(s) 560 trained on potential IT based cyber threats to detect whether the anomalous activity detected, such as suspicious IT links, URLs, domains, user activity, etc., may suggest a malicious intent as indicated by the AI models trained on potential IT based cyber threats.

In the above example, the cyber threat detection engine 130 and/or the cyber threat analyst module 520 can cooperate with the AI model(s) 560 trained with machine learning on the normal pattern of life for entities in an email domain under analysis to detect, in this example, anomalous emails which are detected as outside of the usual pattern of life for each entity, such as a user, email server, etc., of the email network/domain. Likewise, the cyber threat detection engine 130 and/or the cyber threat analyst module 520 can cooperate with the one or more AI models trained with machine learning on the normal pattern of life for entities in a second domain under analysis (in this example, an IT network) to detect, in this example, anomalous network activity by user and/or devices in the network, which is detected as outside of the usual pattern of life (e.g. abnormal) for each entity, such as a user or a device, of the second domain's network under analysis.

Thus, the cyber threat detection engine 130 and/or the cyber threat analyst module 520 can be configured with one or more data analysis processes to cooperate with the one or more of the AI model(s) 560 trained with machine learning on the normal pattern of life in the system, to identify an anomaly of at least one of i) the abnormal behavior, ii) the suspicious activity, and iii) the combination of both, from one or more entities in the system. Note, other sources, such as other model breaches, can also identify at least one of i) the abnormal behavior, ii) the suspicious activity, and iii) the combination of both to trigger the investigation.

Accordingly, during this cyber threat determination process, the cyber threat detection engine 130 and/or the cyber threat analyst module 520 can also use AI classifiers that look at the features and determine a potential maliciousness based on commonality or overlap with known characteristics of malicious processes/entities. Many factors including anomalies that include unusual and suspicious behavior, and other indicators of processes and events are examined by the AI model(s) 560 trained on potential cyber threats and/or the AI classifiers looking at specific features for their malicious nature in order to make a determination of whether an individual factor and/or whether a chain of anomalies is determined to be likely malicious.

Initially, in this example of activity in an IT network analysis, the rare JA3 hash and/or rare user agent connections for this network coming from a new or unusual process are factored just like in the first wireless domain suspicious wireless signals are considered. These are quickly determined by referencing the one or more of the AI model(s) 560 trained with machine learning on the pattern of life of each device and its associated processes in the system. Next, the cyber threat detection engine 130 and/or the cyber threat analyst module 520 can have an external input to ingest threat intelligence from other devices in the network cooperating with the cybersecurity appliance 150. Next, the cyber threat detection engine 130 and/or the cyber threat analyst module 520 can look for other anomalies, such as model breaches, while the AI models trained on potential cyber threats can assist in examining and factoring other anomalies that have occurred over a given timeframe to see if a correlation exists between a series of two or more anomalies occurring within that time frame.

The cyber threat detection engine 130 and/or the cyber threat analyst module 520 can combine these Indicators of Compromise (e.g., unusual network JA3, unusual device JA3, . . . ) with many other weak indicators to detect the earliest signs of an emerging threat, including previously unknown threats, without using strict blacklists or hard-coded thresholds. However, the AI classifiers can also routinely look at blacklists, etc. to identify maliciousness of features looked at.

Another example of features may include a deeper analysis of endpoint data. This endpoint data may include domain metadata, which can reveal peculiarities such as one or more indicators of potentially a malicious domain (i.e., its URL). The deeper analysis may assist in confirming an analysis to determine that indeed a cyber threat has been detected. The cyber threat detection engine 130 can also look at factors of how rare the endpoint connection is, how old the endpoint is, where geographically the endpoint is located, how a security certificate associated with a communication is verified only by an endpoint device or by an external 3rd party, just to name a few additional factors. The cyber threat detection engine 130 (and similarly the cyber threat analyst module 520) can then assign weighting given to these factors in the machine learning that can be supervised based on how strongly that characteristic has been found to match up to actual malicious sites in the training.

In another AI classifier to find potentially malicious indicators, the agent analyzer data analysis process in the cyber threat detection engine 130 and/or cyber threat analyst module 520 may cooperate with the process identifier classifier to identify all of the additional factors of i) are one or more processes running independently of other processes, ii) are the one or more processes running independent are recent to this network, and iii) are the one or more processes running independent connect to the endpoint, which the endpoint is a rare connection for this network, which are referenced and compared to one or more AI models trained with machine learning on the normal behavior of the pattern of life of the system.

Note, a user agent, such as a browser, can function as a client in a network protocol used in communications within a client-server distributed computing system. In particular, the Hypertext Transfer Protocol (HTTP) identifies the client software originating (an example user agent) the request, using a user-agent header, even when the client is not operated by a user. Note, this identification can be faked, so it is only a weak indicator of the software on its own, but when compared to other observed user agents on the device, this can be used to identify possible software processes responsible for requests.

The cyber threat detection engine 130 and/or the cyber threat analyst module 520 may use the agent analyzer data analysis process that detects a potentially malicious agent previously unknown to the system to start an investigation on one or more possible cyber threat hypotheses. The determination and output of this step is what are possible cyber threats that can include or be indicated by the identified abnormal behavior and/or identified suspicious activity identified by the agent analyzer data analysis process.

In an example, the cyber threat analyst module 520 can use the agent analyzer data analysis process and the AI models(s) trained on forming and investigating hypotheses on what are a possible set of cyber threats to use the machine learning and/or set scripts to aid in forming one or more hypotheses to support or refute each hypothesis. The cyber threat analyst module 520 can cooperate with the AI models trained on forming and investigating hypotheses to form an initial set of possible hypotheses, which needs to be intelligently filtered down. The cyber threat analyst module 520 can be configured to use the one or more supervised machine learning models trained on i) agnostic examples of a past history of detection of a multitude of possible types of cyber threat hypotheses previously analyzed by human, who was a cybersecurity professional, ii) a behavior and input of how a plurality of human cybersecurity analysts make a decision and analyze a risk level regarding and a probability of a potential cyber threat, iii) steps to take to conduct an investigation start with anomaly via learning how expert humans tackle investigations into specific real and synthesized cyber threats and then the steps taken by the human cybersecurity professional to narrow down and identify a potential cyber threat, and iv) what type of data and metrics that were helpful to further support or refute each of the types of cyber threats, in order to determine a likelihood of whether the abnormal behavior and/or suspicious activity is either i) malicious or ii) benign?

The cyber threat analyst module 520 using AI models, scripts and/or rules based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

In an example, a behavioural pattern analysis for identifying what are the unusual behaviours of the network/system/device/user under analysis by the AI (machine learning) models may be as follows. The coordinator module 555 can tie the alerts, activities, and events from, in this example, the email domain to the alerts, activities, and events from the IT network domain. Although not shown, a graph of a chain of unusual behaviours for the email activities as well as IT activities deviating from a normal pattern of life for this user and/or device in connection with the rest of the system/network under analysis may be provided by the coordination module 555 and/or other modules of the cybersecurity appliance 150.

The cyber threat analyst module 520 and/or cyber threat detection engine 130 can cooperate with one or more AI (machine learning) models. The one or more AI (machine learning) models are trained and otherwise configured with mathematical algorithms to infer, for the cyber-threat analysis, ‘what is possibly happening with the chain of distinct alerts, activities, and/or events, which came from the unusual pattern,’ and then assign a threat risk associated with that distinct item of the chain of alerts and/or events forming the unusual pattern. The unusual pattern can be determined by examining initially what activities/events/alerts that do not fall within the window of what is the normal pattern of life for that network/system/device/user under analysis can be analysed to determine whether that activity is unusual or suspicious. A chain of related activity that can include both unusual activity and activity within a pattern of normal life for that entity can be formed and checked against individual cyber threat hypothesis to determine whether that pattern is indicative of a behaviour of a malicious actor—human, program, or other threat. The cyber threat analyst module 520 can go back and pull in some of the normal activities to help support or refute a possible hypothesis of whether that pattern is indicative of a behavior of a malicious actor.

As an illustrative example, a behavioral pattern included in a chain of potentially related information (low-level, anomalous behaviors) may extend a prescribed time duration such as a week (7 days) for example. The cyber threat analyst module 520 detects a chain of anomalous behavior of unusual data transfers three times, unusual characteristics in email messages in the monitored system three times which seem to have some causal link to the unusual data transfers. Likewise, twice unusual credentials attempted the unusual behavior of trying to gain access to sensitive areas or malicious IP addresses and the user associated with the unusual credentials trying unusual behavior has a causal link to at least one of those three email messages with unusual characteristics. Again, the cybersecurity appliance 150 can go back and pull in some of the normal activities to help support or refute a possible hypothesis of whether that pattern is indicative of a behaviour of a malicious actor. The cyber threat detection engine 130 of FIG. 5 can cooperate with one or more models trained on cyber threats and their behaviour to try to determine if a potential cyber threat is causing these unusual behaviours. The cyber threat analyst module 520 can put data and entities into 1) a directed graph and nodes in that graph that are overlapping or close in distance have a good possibility of being related in some manner, 2) a vector diagram, 3) relational database, and 4) other relational techniques that will at least be examined to assist in creating the chain of related activity connected by causal links, such as similar time, similar entity and/or type of entity involved, similar activity, etc., under analysis. If the pattern of behaviours under analysis is believed to be indicative of a malicious actor, then a score of how confident is the system in this assessment of identifying whether a malicious actor caused the unusual pattern. Next, also assigned is a threat level score or probability indicative of what level of threat does this malicious actor pose. Lastly, the cybersecurity appliance 150 is configurable in a user interface, by a user, enabling what type of automatic response actions, if any, the cybersecurity appliance 150 may take when different types of cyber threats, indicated by the pattern of behaviours under analysis, that are equal to or above a configurable level of threat posed by this malicious actor.

Referring still to FIG. 5, the autonomous response engine 140 is configured to take one or more autonomous mitigation actions to mitigate the cyber threat during the cyber-attack by the cyber threat. The autonomous response engine 140 can reference an AI model trained to track a normal pattern of life for each node of the protected system to perform an autonomous act of, for example, restricting a potentially compromised node having i) an actual indication of compromise and/or ii) merely adjacent to a known compromised node, to merely take actions that are within that node's normal pattern of life to mitigate the cyber threat.

The chain of the individual alerts, activities, and events that form the pattern including one or more unusual or suspicious activities into a distinct item for cyber-threat analysis of that chain of distinct alerts, activities, and/or events. The cyber-threat module may reference the one or more machine learning models trained on, in this example, e-mail threats to identify similar characteristics from the individual alerts and/or events forming the distinct item made up of the chain of alerts and/or events forming the unusual pattern.

### Cyber Threat Assessment and Autonomous Actions

In the next step, the cyber threat detection engine 130 and/or cyber threat analyst module 520 generates one or more supported possible cyber threat hypotheses from the possible set of cyber threat hypotheses. The cyber threat detection engine 130 generates the supporting data and details of why each individual hypothesis is supported or not. The cyber threat detection engine 130 can also generate one or more possible cyber threat hypotheses and the supporting data and details of why they were refuted.

In general, the cyber threat detection engine 130 cooperates with the following three sources. The cyber threat detection engine 130 cooperates with the one or more of the AI model(s) 560 trained on cyber threats to determine whether an anomaly such as the abnormal behavior and/or suspicious activity is either 1) malicious or 2) benign when the potential cyber threat under analysis is previously unknown to the cybersecurity appliance 150. The cyber threat detection engine 130 cooperates with one or more of the AI model(s) 560 trained on a normal pattern of life of entities in the network under analysis. The cyber threat detection engine 130 cooperates with various AI-trained classifiers. With all of these sources, when they input information that indicates a potential cyber threat that is i) severe enough to cause real harm to the network under analysis and/or ii) a close match to known cyber threats, then the analyzer module can make a final determination to confirm that a cyber threat likely exists and send that cyber threat to the assessment module to assess the threat score associated with that cyber threat. Certain model breaches will always trigger a potential cyber threat that the analyzer will compare and confirm the cyber threat.

In the next step, the assessment module 525 with the AI classifiers is configured to cooperate with the cyber threat detection engine 130. The cyber threat detection engine 130 supplies the identity of the supported possible cyber threat hypotheses from the possible set of cyber threat hypotheses to the assessment module 525. The assessment module 525 with the AI classifiers cooperates with the one or more of the AI model(s) 560 trained on possible cyber threats can make a determination on whether a cyber threat exists and what level of severity is associated with that cyber threat. The assessment module 525 with the AI classifiers cooperates with one or more of the AI model(s) 560 trained on possible cyber threats in order assign a numerical assessment of a given cyber threat hypothesis that was found likely to be supported by the cyber threat detection engine 130 with the one or more data analysis processes, via the abnormal behavior, the suspicious activity, or the collection of system data points. The assessment module 525 with the AI classifiers output can be a score (ranked number system, probability, etc.) that a given identified process is likely a malicious process. The assessment module 525 with the AI classifiers can be configured to assign a numerical assessment, such as a probability, of a given cyber threat hypothesis that is supported and a threat level posed by that cyber threat hypothesis which was found likely to be supported by the cyber threat detection engine 130, which includes the abnormal behavior or suspicious activity as well as one or more of the collection of system data points, with the one or more AI models trained on possible cyber threats.

The cyber threat analyst module 520 in the cybersecurity appliance 150 component provides an advantage over competitors' products as it reduces the time taken for cybersecurity investigations, provides an alternative to manpower for small organizations and improves detection (and remediation) capabilities within the cybersecurity appliance 150. The AI-based, cyber threat analyst module 520 performs its own computation of threat and identifies interesting network events with one or more processers. These methods of detection and identification of threat all add to the above capabilities that make the cyber threat analyst module 520 a desirable part of the cybersecurity appliance 150. The cyber threat analyst module 520 offers a method of prioritizing which is not just a summary or highest score alert of an event evaluated by itself equals the worst and prevents more complex attacks being missed because their composite parts/individual threats only produced low-level alerts.

The AI classifiers can be part of the assessment module 525, which scores the outputs of the cyber threat detection engine 130. Again, as for the other AI classifiers discussed, the AI classifier can be coded to take in multiple pieces of information about an entity, object, and/or thing and based on its training and then output a prediction about the entity, object, or thing. Given one or more inputs, the AI classifier model will try to predict the value of one or more outcomes. The AI classifiers cooperate with the range of data analysis processes that produce features for the AI classifiers. The various techniques cooperating here allow anomaly detection and assessment of a cyber threat level posed by a given anomaly; but more importantly, an overall cyber threat level posed by a series/chain of correlated anomalies under analysis.

In the next step, the formatting module 530 can generate an output such as a printed or electronic report with the relevant data. The formatting module 530 can cooperate with both the analyzer module 515 and the assessment module 525 depending on what the user wants to be reported. The formatting module 530 is configured to format, present a rank for, and output one or more supported possible cyber threat hypotheses from the assessment module into a formalized report, from a one or more report templates populated with the data for that incident. The formatting module 530 is configured to format, present a rank for, and output one or more detected cyber threats from the analyzer module or from the assessment module into a formalized report, from a one or more report templates populated with the data for that incident. Many different types of formalized report templates exist to be populated with data and can be outputted in an easily understandable format for a human user's consumption. The formalized report on the template is outputted for a human user's consumption in a medium of any of 1) printable report, 2) presented digitally on a user interface, 3) in a machine-readable format for further use in machine-learning reinforcement and refinement, or 4) any combination of the three. The formatting module 530 is further configured to generate a textual write up of an incident report in the formalized report for a wide range of breaches of normal behavior, used by the AI models trained with machine learning on the normal behavior of the system, based on analyzing previous reports with one or more models trained with machine learning on assessing and populating relevant data into the incident report corresponding to each possible cyber threat. The formatting module 530 can generate a threat incident report in the formalized report from a multitude of a dynamic human-supplied and/or machine created templates corresponding to different types of cyber threats, each template corresponding to different types of cyber threats that vary in format, style, and standard fields in the multitude of templates. The formatting module 530 can populate a given template with relevant data, graphs, or other information as appropriate in various specified fields, along with a ranking of a likelihood of whether that hypothesis cyber threat is supported and its threat severity level for each of the supported cyber threat hypotheses, and then output the formatted threat incident report with the ranking of each supported cyber threat hypothesis, which is presented digitally on the user interface and/or printed as the printable report.

In the next step, the assessment module 525 with the AI classifiers, once armed with the knowledge that malicious activity is likely occurring/is associated with a given process from the cyber threat detection engine 130, then cooperates with the autonomous response engine 140 to take an autonomous action such as i) deny access in or out of the device or the network ii) shutdown activities involving a detected malicious agent, iii) restrict devices and/or user's to merely operate within their particular normal pattern of life, iv) remove some user privileges/permissions associated with the compromised user account, etc.

The autonomous response engine 140, rather than a human taking an action, can be configured to cause one or more rapid autonomous actions in response to be taken to counter the cyber threat. A user interface for the response module can program the autonomous response engine 140 i) to merely make a suggested response to take to counter the cyber threat that will be presented on a display screen and/or sent by a notice to an enterprise security administrator for explicit authorization when the cyber threat is detected or ii) to autonomously take a response to counter the cyber threat without a need for a human to approve the response when the cyber threat is detected. The autonomous response engine 140 will then send a notice of the autonomous response as well as display the autonomous response taken on the display screen. Example autonomous responses may include cut off connections, shutdown devices, change the privileges of users, delete, and remove malicious links in emails, slow down a transfer rate, cooperate with other security devices such as a firewall to trigger its autonomous actions, and other autonomous actions against the devices and/or users. The autonomous response engine 140 uses one or more of the AI model(s) 560 that are configured to intelligently work with other third-party defense systems in that customer's network against threats. The autonomous response engine 140 can send its own protocol commands to devices and/or take actions on its own. In addition, the autonomous response engine 140 uses the one or more of the AI model(s) 560 to orchestrate with other third-party defense systems to create a unified defense response against a detected threat within or external to that customer's network. The autonomous response engine 140 can be an autonomous self-learning digital response coordinator that is trained specifically to control and reconfigure the actions of traditional legacy computer defenses (e.g., firewalls, switches, proxy servers, etc.) to contain threats propagated by, or enabled by, networks and the internet. The cyber threat analyst module 520 and/or assessment module 525 can cooperate with the autonomous response engine 140 to cause one or more autonomous actions in response to be taken to counter the cyber threat, improves computing devices in the system by limiting an impact of the cyber threat from consuming unauthorized CPU cycles, memory space, and power consumption in the computing devices via responding to the cyber threat without waiting for some human intervention. The trigger module 505, cyber threat detection engine 130, assessment module 525, the cyber threat analyst module 520, and formatting module 530 cooperate to improve the analysis and formalized report generation with less repetition to consume CPU cycles with greater efficiency than humans repetitively going through these steps and re-duplicating steps to filter and rank the one or more supported possible cyber threat hypotheses from the possible set of cyber threat hypotheses.

### VII. Interactive Display Screen Layout

Referring now to FIG. 6, an illustrative embodiment of an interactive display screen 600 rendered by a computing device based on signaling from the orchestration component 110, the first orchestrator (mitigation) module 400, and the second orchestrator (misconfiguration) module 450 is shown. Herein, an interactive display screen 600 operates as a graphic user interface (GUI) with a first display layout rendered and visible in response to activation of an “alert” perspective display element 612 within a first navigation menu 610. The interactive display screen 600 may feature a display region 602, the first navigation menu 610 and a second navigation menu 620. According to this embodiment of the disclosure, the first navigation menu 610 is positioned above the display region 602 and the second navigation menu 620 is positioned along a side of the display region 602.

As shown, the second navigation menu 620 features selectable display elements, including a first display element 630 that categorizes alerts based on the risk level. The alerts can be categorized as “critical” alerts 635 (e.g., alerts pertaining to cloud resources or cloud architectures with the highest risk levels), “suspicious” alerts 640 (e.g., alerts pertaining to cloud resources or cloud architectures with lower risk levels than the “critical” alerts and/or less time sensitive), and/or misconfiguration alerts 645 (e.g., alerts pertain to misconfigurations of cloud resources and/or cloud architectures).

The adjustment of the sensitivity of the cyber threat detection engine 130 of FIG. 1 may be accomplished through administrator alerts generated for display on the interactive display screen 600. In response, the adjustment of threat detection operability may be accomplished by adjusting the alert notification scheme through visual enhancement of the alerts (e.g., prioritizing order of alerts with alerts identified in the threat landscape information given higher priority, adjusting display location of the alert, changing a visual rendering of the alert (e.g., changing font, font color, font size, etc.)), activating one or more additional alert delivery schemes (e.g., text alert, audio notification, etc.). Some of the visual enhancement possibilities may include an optional pre-threat landscape 650 that illustrates prior alert sequence without consideration of the threat technique data and threat landscape adjustment visualizations 652, 654, 656 in which the displayed alert sequences are based on altering font for certain alerts based on threat technique data detected from the threat landscape data, such as changing font type 652, changing alert sequence order 654, changing font type and order 656 are shown in FIG. 6.

As further shown, the second navigation menu 620 features a second display element 660. Although the resultant visual representations are not shown, upon selection, second display element 660 may cause the display of the response actions (prioritize based on effect to address the cyber threat and a current state of the response action based on the threat landscape data (e.g., increased severity, decreased severity, neutral, heightened response action set, etc.).

### VIII. AI-Based Cybersecurity System Physical Architecture

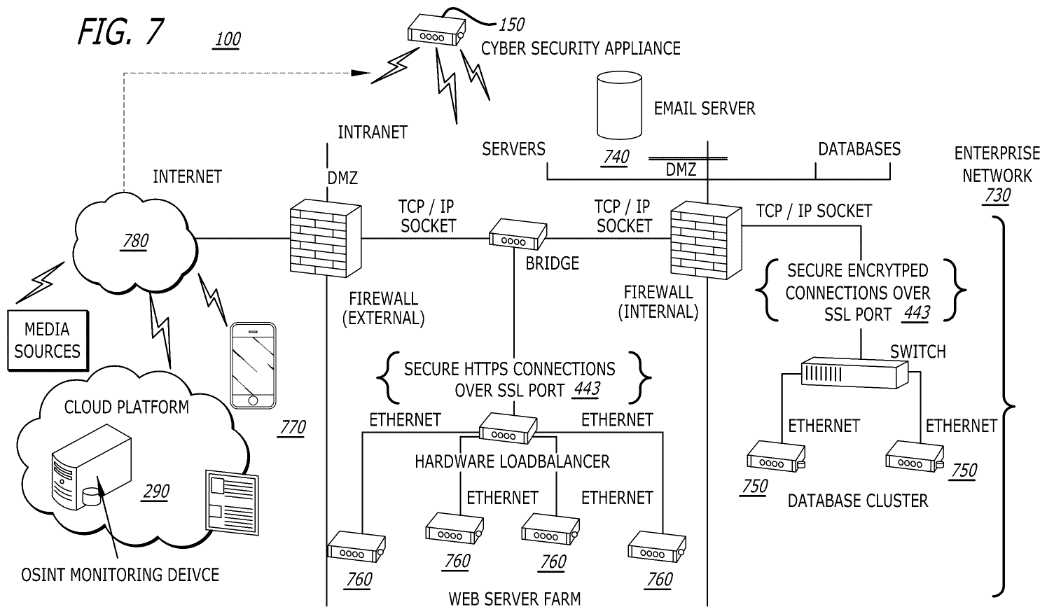

Referring to FIG. 7, an embodiment of the AI-based cybersecurity system 100 plugging in as an appliance platform to protect an enterprise is shown. The AI-based cybersecurity system 100 is part of an enterprise network 730, which may further include one or more computing devices 740 such as database servers 750, web servers 760, networking devices 770 (e.g., bridge, switch, router, load-balancers, gateways, and/or firewalls), endpoint devices with connectivity to resources within the enterprise network 730 as well as a publicly accessible network 780 (e.g., the Internet). The endpoint devices 770 may include, but are not limited or restricted to desktop computers, laptops, smart phones, tablets, wearables, smart appliances, or the like. The security controls operate as probes and detectors that are configured to monitor, for example, network-based activity (e.g., email activity, TCP/IP communications, text or Short Message Service (SMS) activity, etc.) and computing device activity (e.g., download activity based on volume, day, time of day, etc.); credential update/modification activity (e.g., credential changes, failed access attempts to a resource, etc.); and/or resource activity (e.g., attempted/successful accesses to enterprise resources, etc.). The security controls provide the monitored data (or a version of the monitored data) as input into logic of the AI-based cybersecurity system 100 to determine what is occurring in each domain individually.

### Computing Devices

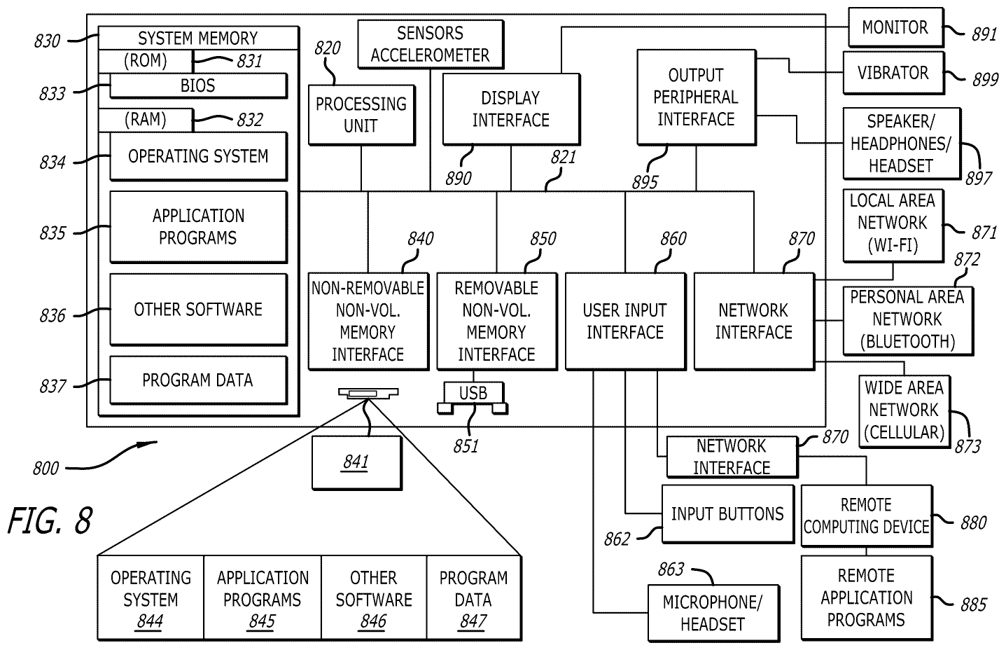

Referring to FIG. 8, an exemplary block diagram of an embodiment of a computing device that can be part of an AI-based cybersecurity system including the cybersecurity appliance 150 and operating with the orchestration component 110 is shown. The computing device may include one or more processors (e.g. processing units) 820 to execute instructions, one or more memories 830-832 to store information, one or more data input components 860-863 to receive data input from a user of the computing device 800, one or more modules that include the management module, a network interface communication circuit 870 to establish a communication link to communicate with other computing devices external to the computing device, one or more sensors where an output from the sensors is used for sensing a specific triggering condition and then correspondingly generating one or more preprogrammed actions, a display monitor 891 to display at least some of the information stored in the one or more memories 830-832 and other components. Note, portions of this design implemented in software 844, 845, 846 are stored in the one or more memories 830-832 and are executed by the one or more processors 820. The processor(s) 820 may have one or more processing cores, which couples to a system bus 821 that couples various system components including the system memory 830. The system bus 821 may be any of several types of bus structures selected from a memory bus, an interconnect fabric, a peripheral bus, and a local bus using any of a variety of bus architectures.

Computing device 800 typically includes a variety of computing machine-readable media. Non-transitory machine-readable media can be any available media that can be accessed by computing device 800 and includes both volatile and nonvolatile media, and removable and non-removable media. By way of example, and not limitation, non-transitory machine-readable media use includes storage of information, such as computer-readable instructions, data structures, other executable software, or other data. Non-transitory machine-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 800. Transitory media such as wireless channels are not included in the machine-readable media. Machine-readable media typically embody computer readable instructions, data structures, and other executable software.

In an example, a volatile memory drive 841 is illustrated for storing portions of the operating system 844, application programs 845, other executable software 846, and program data 847.

A user may enter commands and information into the computing device 800 through input devices such as a keyboard, touchscreen, or software or hardware input buttons 862, a microphone 863, a pointing device and/or scrolling input component, such as a mouse, trackball, or touch pad 861. The microphone 863 can cooperate with speech recognition software. These and other input devices are often connected to the processor(s) 820 through a user input interface 860 that is coupled to the system bus 821, but can be connected by other interface and bus structures, such as a lighting port, game port, or a universal serial bus (USB). The display monitor 891 or other type of display screen device is also connected to the system bus 821 via an interface, such as a display interface 890. In addition to the display monitor 891, computing devices may also include other peripheral output devices such as speakers 897, a vibration device 899, and other output devices, which may be connected through an output peripheral interface 895.

The computing device 800 can operate in a networked environment using logical connections to one or more remote computers/client devices, such as a remote computing device 880. The remote computing device 880 can a personal computer, a mobile computing device, a server, a router, a network PC, a peer device, or other common network node, and typically includes many or all of the elements described above relative to the computing device 800. The logical connections can include a personal area network (PAN) 872 (e.g., Bluetooth®), a local area network (LAN) 871 (e.g., Wi-Fi), and a wide area network (WAN) 873 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 800 is connected to the LAN 871 through the network interface communication circuit 870, which can be, for example, a Bluetooth® or Wi-Fi adapter. When used in a WAN networking environment (e.g., Internet), the computing device 800 typically includes some means for establishing communications over the WAN 873. With respect to mobile telecommunication technologies, for example, a radio interface, which can be internal or external, can be connected to the system bus 821 via the network interface communication circuit 870, or other appropriate mechanism. In a networked environment, other software depicted relative to the computing device 800, or portions thereof, may be stored in the remote memory storage device. By way of example, and not limitation, remote application programs 885 as reside on remote computing device 880. It will be appreciated that the network connections shown are examples and other means of establishing a communications link between the computing devices that may be used. It should be noted that the present design can be conducted on a single computing device or on a distributed system in which different portions of the present design are conducted on different parts of the distributed computing system.

### Cyber-Attack Simulation and Restoration Engines

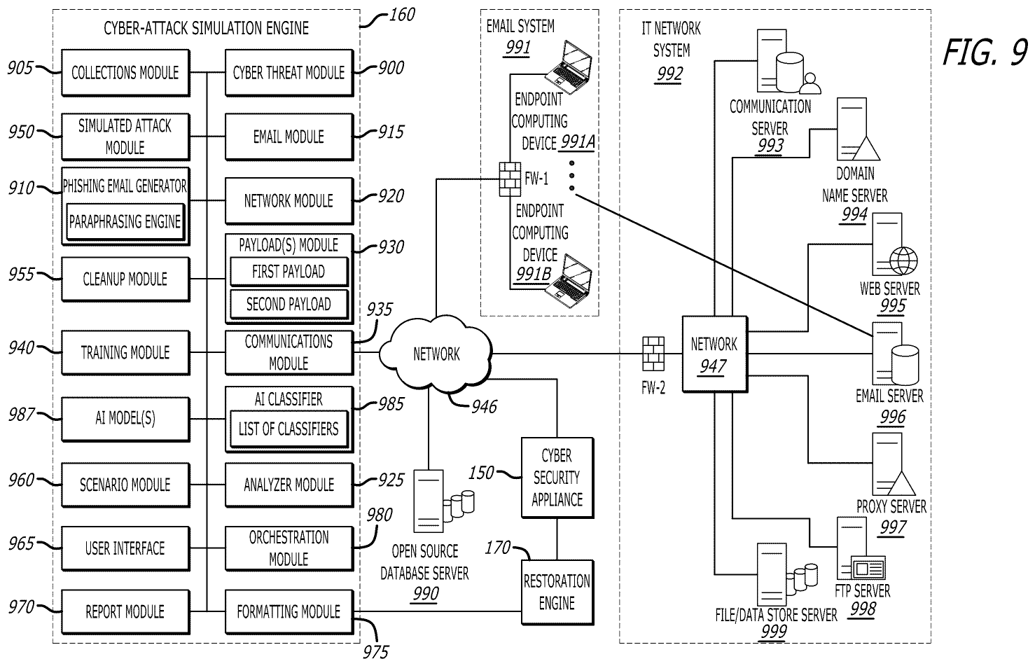

Overall, the cybersecurity appliance 150 and its modules use Artificial Intelligence algorithms configured and trained to perform a first machine-learned task of detecting the cyber threat as well as the autonomous response engine 140 can use a combination of user configurable settings on actions to take to mitigate a detected cyber threat, a default set of actions to take to mitigate a detected cyber threat, and Artificial Intelligence algorithms configured and trained to perform a second machine-learned task of taking one or more mitigation actions to mitigate the cyber threat. The cyber-attack restoration engine 170 deployed in the cybersecurity appliance 150 uses AI-based algorithms configured and trained to perform a third machine-learned task of remediating the system/network being protected back to a trusted operational state. The cyber-attack engine 900 of FIG. 9 uses Artificial Intelligence algorithms configured and trained to perform a fourth machine-learned task of AI-based simulations of cyber-attacks to assist in determining 1) how a simulated cyber-attack might occur in the system being protected, and 2) how to use the simulated cyber-attack information to preempt possible escalations of an ongoing actual cyber-attack.

Referring now to FIG. 9, an embodiment of the AI-based cyber security appliance operating in concert with the intelligent orchestration component is shown. Herein, the cyber-attack simulation engine 160 conducts AI-based simulations by constructing a graph of nodes of the system being protected (e.g., a network including (a) the physical devices connecting to the network, any virtualized instances of the network, user accounts in the network, email accounts in the network, etc. as well as (b) connections and pathways through the network) to create a virtualized instance of the network to be evaluated. As shown in FIG. 9, the various cooperating modules residing in the cyber-attack simulation engine 160 may include, but are not limited to, a collections module 905, a cyber-attack generator (e.g. phishing email generator) 910, an email module 915, a network module 920, an analyzer module 925, a payloads module 930 with first and second payloads, a communication module 935, a training module 940, a simulated attack module 950, a cleanup module 955, a scenario module 960, a user interface 965, a reporting module 970, a formatting module 975, an orchestration interface module 980, and/or an AI classifier 985 with a list of specified classifiers.

The simulated attack module 950 in the cyber-attack simulation engine 160 may be implemented via i) a simulator to model the system being protected and/or ii) a clone creator to spin up a virtual network and create a virtual clone of the system being protected configured to pen-test one or more defenses provided by the cybersecurity appliance 150. The cyber-attack simulation engine 160 may include and cooperate with one or more AI models 987 trained with machine learning on the contextual knowledge of the organization, such as those in the cybersecurity appliance 150 or have its own separate model trained with machine learning on the contextual knowledge of the organization and each user's and device's normal pattern of behavior. These trained AI models 987 may be configured to identify data points from the contextual knowledge of the organization and its entities, which may include, but is not limited to, language-based data, email/network connectivity and behavior pattern data, and/or historic knowledgebase data. The cyber-attack simulation engine 160 may use the trained AI models 987 to cooperate with one or more AI classifier(s) 985 by producing a list of specific organization-based classifiers for the AI classifier(s) 985.

The simulated attack module 950 by cooperating with the other modules in the cyber-attack simulation engine 160 is further configured to calculate and run one or more hypothetical simulations of a possible cyber-attack and/or of an actual ongoing cyber-attack from a cyber threat through an attack pathway through the system being protected. The cyber-attack simulation engine 160 is further configured to calculate, based at least in part on the results of the one or more hypothetical simulations of a possible cyber-attack and/or of an actual ongoing cyber-attack from a cyber threat through an attack pathway through the system being protected, a risk score for each node (e.g. each device, user account, etc.), the threat risk score being indicative of a possible severity of the compromise and/or chance of compromise prior to an autonomous response action is taken in response to an actual cyber-attack of the cyber incident.

The simulated attack module 950 is configured to initially create the network being protected in a simulated or virtual device environment. Additionally, the orchestration module 980 and communication module 935 may be configured to cooperate with the cybersecurity appliance 150 to securely obtain specific data about specific users, devices, and entities in specific networks of for this specific organization. The training module 940 and simulated attack module 950 in the cyber-attack simulation engine 160 use the obtained specific data to generate one or more specific cyber-attacks, such as a phishing email, tailored to those specific users, devices, and/or entities of the specific organization. Many different cyber-attacks can be simulated by the AI red team module but a phishing email attack will be used as an example cyber-attack.

The cyber-attack simulation engine 160 is communicatively coupled to the cybersecurity appliance 150, an open source (OS) database server 990, an email system 991 with one or more endpoint computing devices 991A-B, and a network system 992 with one or more entities 993-799, and the cyber-attack restoration engine 170 over one or more networks 946/947. The cybersecurity appliance 150 may cooperate with the cyber-attack simulation engine 160 to initiate a pen-test in the form of, for example, a software attack, which generates a customized, for example, phishing email to spoof one or more specific users/devices/entities of an organization in an email/network defense system and then looks for any security vulnerabilities, risks, threats, and/or weaknesses potentially gaining access to one or more features and data of that specific user/device/entity.

The cyber-attack simulation engine 160 may be customized and/or driven by a centralized AI using and/or modelling a smart awareness of a variety of specific historical email/network behavior patterns and communications of a specific organization's hierarchy within a specific organization. Such AI modelling may be trained and derived through machine learning and the understanding of the organization itself based on: (i) a variety of OS materials such as any OS materials collected from the OS database server 990 and (ii) its historical awareness of any specific email/network connectivity and behavior patterns to target for that organization as part of an offensive (or attacking) security approach. The training module 940 can contain for reference a database of cyber-attack scenarios as well as restoration response scenarios by the cyber-attack restoration engine 170 stored in the database.

The cyber-attack simulation engine 160 may use the orchestration module 980 to implement and orchestrate this offensive approach all the way from an initial social engineering attack at an earlier stage of the pentest to a subsequent payload delivery attack at a later stage of the pentest and so on. The cyber-attack simulation engine 160 is configured to: (i) intelligently initiate a customized cyber-attack on the components, for example, in the IT network and email system 991; as well as (ii) subsequently generating a report to highlight and/or raise awareness of one or more key areas of vulnerabilities and/or risks for that organization after observing the intelligently initiated attack (e.g., such key areas may be formatted and reported in a way tailored for that organization using both the formatting and reporting modules, as described below); and (iii) then allow that enterprise (e.g., organization) to be trained on that attack and its impact on those specific security postures, thereby allowing that organization to go in directly to mitigate and improve those compromised security postures going forward, as well as iv) during an actual cyber-attack, obtain and ingest data known on the cyber-attack, run simulations, and then supply information, for example, to the autonomous response module in the cybersecurity appliance to mitigate the actual cyber-attack.

The cyber-attack simulation engine 160 may cooperate with the cybersecurity appliance 150 to provide feedback on any successful attacks and detections. For example, in the event that the cyber-attack simulation engine 160 is successful in pentesting any of the organization's entities in the email and network defense systems 991/992, the cyber-attack simulation engine 160 may be configured to at least provide the cybersecurity appliance 150 (and/or any other predetermined entities) with any feedback on the successful pentest as well as any specifics regarding the processes uses for that successful pentest, such as providing feedback on the specific attack vectors, scenarios, targeted entities, characteristics of the customized phishing emails, payloads, and contextual data, etc., that were used.

The simulated attack module 950 in the cyber-attack simulation engine 160 may be configured with an attack path modeling component (not shown), which is programmed to work out the key paths and devices in a network via running cyber-attacks on a simulated or virtual device version of the network under analysis incorporating metrics that feed into that modeling by running simulated cyber-attacks on the particulars known about this specific network being protected by the cybersecurity appliance 150. The attack modeling has been programmed with the knowledge of a layout and connection pattern of each particular network device in a network and a number of connections and/or hops to other network devices in the network. Also, how important a particular device (a key importance) can be determined by the function of that network device, the user(s) associated with that network device, the location of the device within the network and a number of connections and/or hops to other important devices in the network. The attack path modeling component ingests the information for the purposes of modeling and simulating a potential attack against the network and routes that an attacker would take through the network. The attack path modeling component can be constructed with information to i) understand an importance of network nodes in the network compared to other network nodes in the network, and ii) to determine key pathways within the network and vulnerable network nodes in the network that a cyber-attack would use during the cyber-attack, via modeling the cyber-attack on at least one of 1) a simulated device version and 2) a virtual device version of the network under analysis.

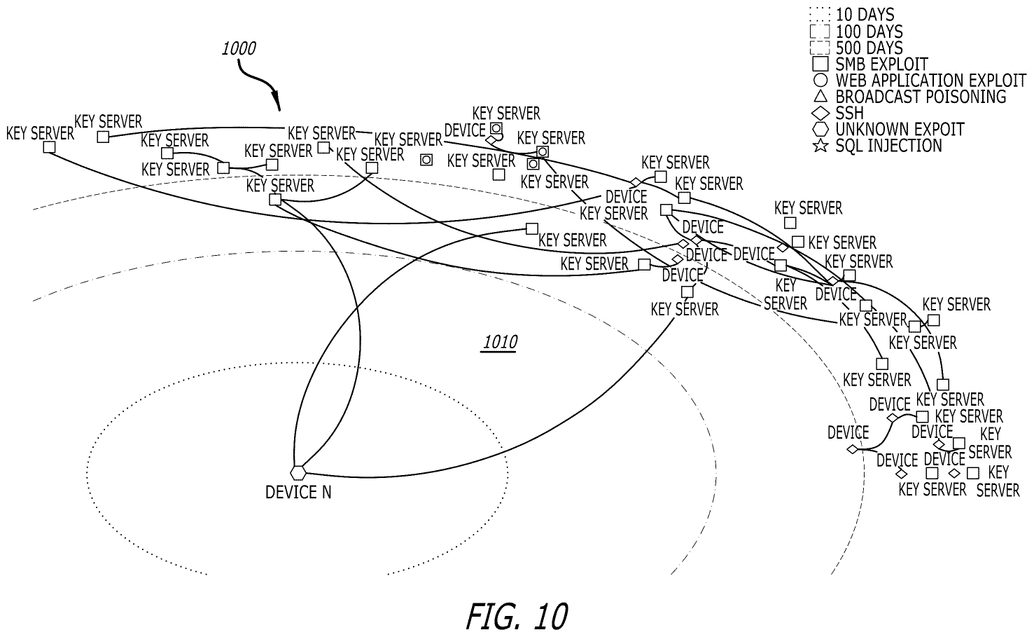

FIG. 10 illustrates a diagram of an embodiment of the cybersecurity appliance and its AI-based simulations constructing an example graph of nodes 1000 in an example network and simulating how the cyber-attack might likely progress in the future tailored with an innate understanding of a normal behavior of the nodes in the system being protected and a current operational state of each node in the graph of the protected system during simulations of cyber-attacks. The cyber-attack simulation engine 160 plots the attack path through the nodes and estimated times to reach critical nodes in the network. The cyber-attack simulation modeling is run to identify the routes, difficulty, and time periods from certain entry notes to certain key servers. The simulations of the cyber-attack by the cyber threat from one compromised entry point such as Device n to a key server can take 10 days, 100 days, etc. depending on normal behavior of Device n, security settings of the network devices in the different nodes of the network, etc.

Referring back to FIG. 9, the attack path modeling component in the simulated attack module 950 cooperating with the other modules in the cyber-attack simulation engine 160 are configured to determine the key pathways within the network and the vulnerable network nodes in the network that the cyber-attack would use during the cyber-attack, via the modeling of the cyber-attack on at least one of 1) the simulated device version and 2) the virtual device version of the network under analysis via using the actual detected vulnerabilities of each network node, a predicted frequency of remediation of those vulnerabilities within a specific network device in the network without a notice from the cyber-attack restoration engine 170, and an importance of the key network nodes with the actual vulnerabilities compared to other network nodes in the network.

The modules essentially seed the attack path modeling component with weakness scores that provide current data, customized to each user account and/or network device, which then allows the artificial intelligence running the attack path simulation to choose entry network nodes into the network with more accuracy as well as plot the attack path through the nodes and estimated times to reach critical nodes in the network much more accurately based on the actual current operational condition of the many user accounts and network devices in the network. The attack simulation modeling can be run to identify the routes, difficulty, and time periods from certain entry notes to certain key servers.

Note, the cyber threat analyst module 520 in the cybersecurity appliance 150 of FIG. 5 as well as the cyber-attack simulation engine 160 of FIG. 9 may use any unusual, detected behavior deviating from the normal behavior and then build a sequence/chain of unusual behavior and the causal links between the sequence/chain of unusual behavior to detect any potential cyber threats. For example, the cyber threat detection engine 130 and the cyber-attack simulation engine 160 may determine the unusual patterns by analyzing i) what activities/events/alerts that fall outside of the window of what is the normal pattern of life for that network/system/entity/device/user under analysis; and (ii) then pulling in and analyzing the pattern of the behavior of the activities/events/alerts that are in the normal pattern of life but also connect to the indictors for a possible cyber-attack, to determine whether that pattern is indicative of a behavior of a malicious actor, such as a human, program, and/or any other cyber harmful threat.

The cyber-attack simulation engine 160 and its AI-based simulations use artificial intelligence to cooperate with the cyber-attack restoration engine 170 to assist in choosing one or more remediation actions to perform on nodes affected by the cyber-attack back to a trusted operational state while still mitigating the cyber threat during an ongoing cyber-attack based on effects determined through the simulation of possible remediation actions to perform and their effects on the nodes making up the system being protected and preempt possible escalations of the cyber-attack while restoring one or more nodes back to a trusted operational state. Thus, for example, the cyber-attack restoration engine 170 restores the one or more nodes in the protected system by cooperating with any of 1) an AI model trained to model a normal pattern of life for each node in the protected system, 2) an AI model trained on what are a possible set of cyber threats and their characteristics and symptoms to identify the cyber threat (e.g. malicious actor/device/file) that is causing a particular node to behave abnormally (e.g. malicious behavior) and fall outside of that node's normal pattern of life, and 3) the autonomous response engine 140.

The cyber-attack restoration engine 170 can reference both i) a database of restoration response scenarios stored in the database and ii) a cyber-attack simulation engine 160 configured to run AI-based simulations and use the operational state of each node in the graph of the protected system during simulations of cyber-attacks on the protected system to restore 1) each node compromised by the cyber threat and 2) promote protection of the corresponding nodes adjacent to a compromised node in the graph of the protected system.

The cyber-attack restoration engine 170 can prioritize among the one or more nodes to restore, which nodes to remediate and an order of the nodes to remediate, based on two or more factors including i) a dependency order needed for the recovery efforts, ii) an importance of a particular recovered node compared to other nodes in the system being protected, iii) a level of compromise of a particular node contemplated to be restored, iv) an urgency to recover that node compared to whether containment of the cyber threat was successful, v) a list of a most important things in the protected system to recover earliest, and vi) factoring in a result of a cyber-attack simulation being run during the cyber-attack by the cyber-attack simulation engine 160 to predict a likely result regarding the cyber-attack when that node is restored.

An interactive response loop exists between the cyber-attack restoration engine 170, the cybersecurity appliance 150, and the cyber-attack simulation engine 160. The cyber-attack restoration engine 170, the cybersecurity appliance 150, and the cyber-attack simulation engine 160 can be configured to cooperate to combine an understanding of normal operations of the nodes making up the devices and users in the system being protected by the cybersecurity appliance 150, an understanding emerging cyber threats, an ability to contain those emerging cyber threats, and a restoration of the nodes of the system to heal the system with an adaptive feedback between the multiple AI-based engines in light of simulations of the cyber-attack to predict what might occur in the nodes in the system based on the progression of the attack so far, mitigation actions taken to contain those emerging cyber threats and remediation actions taken to heal the nodes using the simulated cyber-attack information. The multiple AI-based engines have communication hooks in between them to exchange a significant amount of behavioral metrics including data between the multiple AI-based engines to work in together to provide an overall cyber threat response.

The cybersecurity appliance 150 and its modules use Artificial Intelligence algorithms configured and trained to perform a first machine-learned task of detecting the cyber threat as well as the autonomous response engine 140 can use a combination of user configurable settings on actions to take to mitigate a detected cyber threat, a default set of actions to take to mitigate a detected cyber threat, and Artificial Intelligence algorithms configured and trained to perform a second machine-learned task of taking one or more mitigation actions to mitigate the cyber threat. The cyber-attack restoration engine 170 uses Artificial Intelligence algorithms configured and trained to perform a third machine-learned task of remediating the system/network being protected back to a trusted operational state. The cyber-attack simulation engine 160 uses Artificial Intelligence algorithms configured and trained to perform a fourth machine-learned task of AI-based simulations of cyber-attacks to assist in determining 1) how a simulated cyber-attack might occur in the system being protected, and 2) how to use the simulated cyber-attack information to preempt possible escalations of an ongoing actual cyber-attack. In an example, the autonomous response engine 140 uses its intelligence to cooperate with the cyber-attack simulation engine 160 and its AI-based simulations to choose and initiate an initial set of one or more mitigation actions indicated as a preferred targeted initial response to the detected cyber threat by autonomously initiating those mitigation actions to defend against the detected cyber threat, rather than a human taking an action.

The method and system are arranged to be performed by one or more processing components with any portions of software stored in an executable format on a computer readable medium. Thus, any portions of the method, apparatus and system implemented as software can be stored in one or more non-transitory memory storage devices in an executable format to be executed by one or more processors. The computer readable medium may be non-transitory and does not include radio or other carrier waves. The computer readable medium could be, for example, a physical computer readable medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD.

The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

In certain situations, each of the terms “engine,” “logic,” “component,” “module,” and “element” may be representative of hardware, firmware, and/or software that is configured to perform one or more functions. As hardware, the engine (or logic, component, module, or element) may include circuitry having data processing and/or storage functionality. Examples of such circuitry may include, but are not limited or restricted to a processor, a programmable gate array, a microcontroller, an application specific integrated circuit, wireless receiver, transmitter and/or transceiver circuitry, semiconductor memory, or combinatorial logic. Alternatively, or in combination with the hardware circuitry described above, the engine (or module or component) may be software in the form of one or more software modules, which may be configured to operate as its counterpart circuitry. For instance, a software module may be a software instance that operates as or is executed by a processor, namely a virtual processor whose underlying operations is based on a physical processor such as virtual processor instances for Microsoft® Azure® or Google® Cloud Services platform or an EC2 instance within the Amazon® AWS infrastructure, for example. Illustrative examples of the software module may include an executable application, a daemon application, an application programming interface (API), a subroutine, a function, a procedure, an applet, a servlet, a routine, source code, a shared library/dynamic load library, or simply one or more instructions. A module may be implemented in hardware electronic components, software components, and a combination of both. A module is a core component of a complex system consisting of hardware and/or software that is capable of performing its function discretely from other portions of the entire complex system but designed to interact with the other portions of the entire complex system. The term “computerized” generally represents that any corresponding operations are conducted by hardware in combination with software and/or firmware. The terms “computing device” or “device” should be generally construed as physical device with data processing capability, data storage capability, and/or a capability of connecting to any type of network, such as a public cloud network, a private cloud network, or any other network type. Examples of a computing device may include, but are not limited or restricted to, the following: a server, a router or other intermediary communication device, an endpoint (e.g., a laptop, a smartphone, a tablet, a desktop computer, a netbook, IoT device, networked wearable, etc.) Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. Note, many functions performed by electronic hardware components can be duplicated by software emulation. Thus, a software program written to accomplish those same functions can emulate the functionality of the hardware components in the electronic circuitry.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Additionally, the term “message” generally refers to information transmitted in one or more electrical signals that collectively represent electrically stored data in a prescribed format. Each message may be in the form of one or more packets, frames, HTTP-based transmissions, or any other series of bits having the prescribed format. The message may include any type of signaling.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A non-transitory storage medium including software configured, when executed by one or more processors, to enhance cyber threat detection or a response to a cyber threat detected by a cybersecurity appliance of a cybersecurity system, the software comprising:
a first orchestrator module deployed with at least a first large language model that is configured, when executed by the one or more processors, to perform artificial intelligence-based simulations of cyber-attacks, to assist in determining (i) how a simulated cyber-attack might occur in a selected computing device protected by the cybersecurity system, and (ii) how to use simulated cyber-attack information to preempt possible escalations of an ongoing actual cyber-attack; and
a second orchestrator module deployed with at least a second large language model that is configured, when executed by the one or more processors, to perform a remediation task to correct one or more misconfigurations in one or more components associated with the cybersecurity system and return the one or more components back to a trusted operational state.

2. The non-transitory storage medium of claim 1, wherein the first orchestrator module comprises a mitigation remediation suggestion module configured to initiate a series of application programming interface (API) calls to multiple computing devices including the selected computing device to acquire information associated with the computing devices including external exposure information associated with each of the computing devices.

3. The non-transitory storage medium of claim 2, wherein the acquired information includes (1) user context information, (2) known cyber-attack paths, and (3) pattern of life event data that provides an intrinsic understanding of normal behaviors for the selected computing device or a user of the selected computing device.

4. The non-transitory storage medium of claim 3, wherein the pattern of life event data includes (i) traffic pattern, and (ii) log that maintains a record of incoming and outgoing network traffic including blocked connections and communication attempts and access logs that maintain successful logins and unauthorized access attempts from unexpected locations could indicate external communication.

5. The non-transitory storage medium of claim 2, wherein the mitigation remediation suggestion module is further configured to assign an external exposure score to each analyzed computing device to prioritize a prescribed number of the computing devices with a greatest external exposure.

6. The non-transitory storage medium of claim 5, wherein the mitigation remediation suggestion module is further configured to conduct analytics on functionality of the prescribed number of computing devices with the greatest external exposure score, the functionality includes an analysis of one or more settings of the prescribed number of computing devices, a status of software updates, a presence of software modules unnecessary for an intended operability of each of the prescribed number of computing devices.

7. The non-transitory storage medium of claim 5, wherein the mitigation remediation suggestion module is further configured to (i) access a threat technique data store including threat technique data associated with threat landscape data gathered by the cybersecurity system and (ii) determine if any mitigation suggestions aligns with the stored threat technique data and factor any alignment into a first recommendation message output by the mitigation remediation suggestion module.

8. The non-transitory storage medium of claim 2, wherein the second orchestrator module comprises a misconfiguration remediation suggestion module configured to establish communications with and acquire information from the one or more components, the acquired information includes detected misconfigurations of the one or more components provided from a cloud service provider along with cloud resource information that provides additional context associated with the one or more components.

9. The non-transitory storage medium of claim 8, wherein the misconfiguration remediation suggestion module is further configured to establish communications with the cybersecurity appliance to obtain information associated with threat landscape data and to factor the information into a second recommendation message output by the misconfiguration remediation suggestion module, the second recommendation message includes a listing of steps to perform correct a misconfiguration or increase network security.

10. A system operating with a cybersecurity system to enhance cyber threat detection, comprising:
a first orchestrator module including at least a first large language model configured to perform artificial intelligence-based simulations of cyber-attacks, to assist in determining (i) how a simulated cyber-attack might occur in a selected computing device, and (ii) how to use simulated cyber-attack information to preempt possible escalations of an ongoing actual cyber-attack;
a second orchestrator module including at least a second large language model configured to perform a remediation task to correct one or more misconfigurations in one or more components associated with the cybersecurity system and return the one or more components back to a trusted operational state; and
where instructions implemented in software for the first orchestrator module, the second orchestrator module, the first large language model, and the second large language model are configured to be stored in one or more non-transitory storage mediums to be executed by one or more processing units.

11. The system of claim 10, wherein the first orchestrator module comprises a mitigation remediation suggestion module configured to initiate a series of application programming interface (API) calls to multiple computing devices including the selected computing device to acquire information associated with the computing devices including external exposure information associated with each of the computing devices.

12. The system of claim 11, wherein the acquired information includes (1) user context information, (2) known cyber-attack paths, and (3) pattern of life event data that provides an intrinsic understanding of normal behaviors for the selected computing device or a user of the selected computing device.

13. The system of claim 12, wherein the pattern of life event data includes (i) traffic pattern for the user, and (ii) log that maintains a record of incoming and outgoing network traffic including blocked connections and communication attempts and access logs that maintain successful logins and unauthorized access attempts from unexpected locations could indicate external communication.

14. The system of claim 11, wherein the mitigation remediation suggestion module is further configured to (i) assign an external exposure score to each analyzed computing device of the multiple computing devices to prioritize a prescribed number of the computing devices with a greatest external exposure, (ii) conduct analytics on functionality of the prescribed number of computing devices with the greatest external exposure score, the functionality includes one or more settings of the prescribed number of computing devices, a status of software updates, a presence of software modules unnecessary for an intended operability of each of the prescribed number of computing devices, (iii) a threat technique data store within a cybersecurity appliance of the cybersecurity system to obtain threat technique data associated with threat landscape data gathered by the cybersecurity system, and (iv) determine if any mitigation suggestions aligns with the stored threat technique data and factor any alignment into a first recommendation message output by the mitigation remediation suggestion module.

15. The system of claim 11, wherein the second orchestrator module comprises a misconfiguration remediation suggestion module configured to establish communications with and acquire information associated with misconfigurations of the one or more components provided from a cloud service provider along with cloud resource information that provides additional context associated with the one or more components.

16. The system of claim 15, wherein the misconfiguration remediation suggestion module is further configured to establish communications with a cybersecurity appliance of the cybersecurity system to obtain information associated with gathered threat landscape data and to factor the obtained information into a second recommendation message output by the misconfiguration remediation suggestion module, the second recommendation message includes a listing of steps to perform correct a misconfiguration or increase network security.

17. A method for enhancing cyber threat detection by a cybersecurity system and actions to mitigate cyber threat activity, comprising:
performing, using a large language model, artificial intelligence-based simulations of cyber-attacks to assist in determining (i) how a simulated cyber-attack might occur in a selected computing device and (ii) how to use simulated cyber-attack information to preempt possible escalations of an ongoing actual cyber-attack; and
performing, using the large language model, a remediation task to correct one or more misconfigurations in one or more components associated with the cybersecurity system and return the one or more components back to a trusted operational state.

18. The method of claim 17, wherein prior to performing the artificial intelligence-based simulations, the method further comprises (i) initiating a series of application programming interface (API) calls to multiple computing devices to acquire external exposure information associated with each of the multiple computing devices and (ii) assigning an external exposure score to each analyzed computing device of the multiple computing devices to prioritize a prescribed number of the multiple computing devices with a greatest external exposure.

19. The method of claim 18, wherein the performing of the remediation task comprises acquiring information associated with misconfigurations of the one or more components provided from a cloud service provider along with cloud resource information that provides additional context associated with the one or more components.

20. A non-transitory storage medium comprising computer readable code operable, when executed by one or more processing apparatuses in a computing system to instruct a computing device to perform the method of claim 17.
